(19) United States
(12) Patent Application Publication
(10) Pub. No.: US 2026/0261914 A1
(43) Pub. Date: Sep. 3, 2026

(54) SERVICE LEVEL AGREEMENT TRAFFIC FLOW CONTROL

(71) Applicant: QUALCOMM Incorporated, San Diego, CA (US)

(72) Inventors: Prasanthi MUPPIREDDY, San Jose, CA (US); Shalabh PARMAR, San Jose, CA (US); Gyanranjan HAZARIKA, Milpitas, CA (US); Harsha VITTAL, Livermore, CA (US); Manish SHUKLA, Milpitas, CA (US); Xiaolong HUANG, Santee, CA (US); Sandip HOMCHAUDHURI, San Jose, CA (US)

(21) Appl. No.: 19/066,863

(22) Filed: Feb. 28, 2025

(51) Int. Cl. H04W 28/12; H04W 28/02; H04W 52/36

(52) U.S. Cl. CPC H04W 28/12; H04W 28/0268; H04W 52/367

(57) ABSTRACT

This disclosure provides methods, components, devices and systems for service level agreement (SLA) traffic flow control. Some aspects more specifically relate to adaptations by an access point (AP) in the event of a Quality of Service (QoS) or SLA breach for a channel or an addition of a new traffic flow to a channel that causes the airtime demand for the channel to exceed an available airtime threshold. A standalone AP that services multiple traffic flows with multiple client wireless communication devices (such as wireless stations (STAs)) may adjust one or more communication parameters to increase the available airtime. An AP in a mesh network may steer a client wireless communication device to another AP in the event of a QoS breach for a channel or an addition of a new traffic flow to a channel that causes the airtime demand for the channel to exceed an available airtime threshold.

### TECHNICAL FIELD

This disclosure relates generally to wireless communication and, more specifically, to service level agreement (SLA) traffic flow control.

### DESCRIPTION OF THE RELATED TECHNOLOGY

Wireless communication networks may include various types of wireless communication devices including network entities (such as wireless access points (AP) or base stations (BS)), client wireless communication devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by an access point (AP). The method may include communicating, at a first time occasion, a first set of traffic flows with a first set of client wireless communication devices in accordance with a first communication resource configuration associated with a first threshold airtime availability, where the first set of traffic flows is associated with a first airtime demand that is less than or equal to the first threshold airtime availability and communicating, at a second time occasion that is after the first time occasion, a second set of traffic flows with a second set of client wireless communication devices in accordance with a second communication resource configuration associated with a second threshold airtime availability, where the second set of client wireless communication devices includes at least the first set of client wireless communication devices, where the second threshold airtime availability is greater than the first threshold airtime availability, where the second set of traffic flows is associated with a second airtime demand that is greater than the first airtime demand, and where communication in accordance with the second communication resource configuration is based on the second airtime demand exceeding the first threshold airtime availability.

Another innovative aspect of the subject matter described in this disclosure can be implemented in an AP for wireless communications. The AP may include a processing system that includes processor circuitry and memory circuitry that stores code. The processing system may be configured to cause the AP to communicate, at a first time occasion, a first set of traffic flows with a first set of client wireless communication devices in accordance with a first communication resource configuration associated with a first threshold airtime availability, where the first set of traffic flows is associated with a first airtime demand that is less than or equal to the first threshold airtime availability and communicate, at a second time occasion that is after the first time occasion, a second set of traffic flows with a second set of client wireless communication devices in accordance with a second communication resource configuration associated with a second threshold airtime availability, where the second set of client wireless communication devices includes at least the first set of client wireless communication devices, where the second threshold airtime availability is greater than the first threshold airtime availability, where the second set of traffic flows is associated with a second airtime demand that is greater than the first airtime demand, and where communication in accordance with the second communication resource configuration is based on the second airtime demand exceeding the first threshold airtime availability.

Another innovative aspect of the subject matter described in this disclosure can be implemented in an AP for wireless communications. The AP may include means for communicating, at a first time occasion, a first set of traffic flows with a first set of client wireless communication devices in accordance with a first communication resource configuration associated with a first threshold airtime availability, where the first set of traffic flows is associated with a first airtime demand that is less than or equal to the first threshold airtime availability and means for communicating, at a second time occasion that is after the first time occasion, a second set of traffic flows with a second set of client wireless communication devices in accordance with a second communication resource configuration associated with a second threshold airtime availability, where the second set of client wireless communication devices includes at least the first set of client wireless communication devices, where the second threshold airtime availability is greater than the first threshold airtime availability, where the second set of traffic flows is associated with a second airtime demand that is greater than the first airtime demand, and where communication in accordance with the second communication resource configuration is based on the second airtime demand exceeding the first threshold airtime availability.

Another innovative aspect of the subject matter described in this disclosure can be implemented in a non-transitory computer-readable medium storing code for wireless communications. The code may include instructions executable by one or more processors to communicate, at a first time occasion, a first set of traffic flows with a first set of client wireless communication devices in accordance with a first communication resource configuration associated with a first threshold airtime availability, where the first set of traffic flows is associated with a first airtime demand that is less than or equal to the first threshold airtime availability and communicate, at a second time occasion that is after the first time occasion, a second set of traffic flows with a second set of client wireless communication devices in accordance with a second communication resource configuration associated with a second threshold airtime availability, where the second set of client wireless communication devices includes at least the first set of client wireless communication devices, where the second threshold airtime availability is greater than the first threshold airtime availability, where the second set of traffic flows is associated with a second airtime demand that is greater than the first airtime demand, and where communication in accordance with the second communication resource configuration is based on the second airtime demand exceeding the first threshold airtime availability.

Some examples of the method, APs, and non-transitory computer-readable medium described herein may further include operations, features, means, or instructions for receiving, after the first time occasion, a request to add a new traffic flow, where the second set of traffic flows includes the first set of traffic flows and the new traffic flow.

In some examples of the method, APs, and non-transitory computer-readable medium described herein, the second set of traffic flows may be a same as the first set of traffic flows.

In some examples of the method, APs, and non-transitory computer-readable medium described herein: the first communication resource configuration may include a first transmission power level, a first quantity of spatial streams, a first quantity of memory, a first quantity of central processing unit resources, a first bandwidth, or a first combination thereof; and the second communication resource configuration may include a second transmission power level greater than the first transmission power level, a second quantity of spatial streams greater than the first quantity of spatial streams, a second quantity of memory greater than the first quantity of memory, a second quantity of central processing unit resources greater than the first quantity of central processing unit resources, a second bandwidth greater than the first bandwidth, or a second combination thereof.

In some examples of the method, APs, and non-transitory computer-readable medium described herein, the first communication resource configuration may be associated with a first energy consumption mode at the AP, the second communication resource configuration may be associated with a second energy consumption mode at the AP, and the second energy consumption mode may be associated with higher power than the first energy consumption mode.

In some examples of the method, APs, and non-transitory computer-readable medium described herein, communicating the second set of traffic flows may include operations, features, means, or instructions for communicating the second set of traffic flows via a second communication channel associated with a second interference level, where the first set of traffic flows may be communicated via a first communication channel associated with a first interference level, and where communication of the second set of traffic flows may be via the second communication channel based on the second interference level being less than the first interference level.

In some examples of the method, APs, and non-transitory computer-readable medium described herein, the second communication resource configuration includes a set of multiple parameters adjusted with respect to the first communication resource configuration and subsets of the set of multiple parameters may be adjusted sequentially in time between the first time occasion and the second time occasion with respective back-off time durations between adjustments of respective subsets.

Another innovative aspect of the subject matter described in this disclosure can be implemented in a method for wireless communications by a first AP. The method may include communicating, at a first time occasion, a first set of traffic flows with a first set of client wireless communication devices, where the first set of traffic flows is associated with a first airtime demand that is less than or equal to a first threshold airtime availability associated with a communication resource configuration at the first AP, communicating, after the first time occasion and with a second AP, a backhaul message that indicates for the second AP to service at least one traffic flow of a second set of traffic flows based on the second set of traffic flows being associated with a second airtime demand that is greater than the first threshold airtime availability, where the second set of traffic flows includes at least the first set of traffic flows and includes the at least one traffic flow and a remainder of the second set of traffic flows, and communicating, based on the backhaul message, the remainder of the second set of traffic flows with one or more client wireless communication devices of the first set of client wireless communication devices, where the remainder of the second set of traffic flows is associated with a third airtime demand that is less than or equal to the first threshold airtime availability.

Another innovative aspect of the subject matter described in this disclosure can be implemented in a first AP for wireless communications. The first AP may include a processing system that includes processor circuitry and memory circuitry that stores code. The processing system may be configured to cause the first AP to communicate, at a first time occasion, a first set of traffic flows with a first set of client wireless communication devices, where the first set of traffic flows is associated with a first airtime demand that is less than or equal to a first threshold airtime availability associated with a communication resource configuration at the first AP, communicate, after the first time occasion and with a second AP, a backhaul message that indicates for the second AP to service at least one traffic flow of a second set of traffic flows based on the second set of traffic flows being associated with a second airtime demand that is greater than the first threshold airtime availability, where the second set of traffic flows includes at least the first set of traffic flows and includes the at least one traffic flow and a remainder of the second set of traffic flows, and communicate, based on the backhaul message, the remainder of the second set of traffic flows with one or more client wireless communication devices of the first set of client wireless communication devices, where the remainder of the second set of traffic flows is associated with a third airtime demand that is less than or equal to the first threshold airtime availability.

Another innovative aspect of the subject matter described in this disclosure can be implemented in a first AP for wireless communications. The first AP may include means for communicating, at a first time occasion, a first set of traffic flows with a first set of client wireless communication devices, where the first set of traffic flows is associated with a first airtime demand that is less than or equal to a first threshold airtime availability associated with a communication resource configuration at the first AP, means for communicating, after the first time occasion and with a second AP, a backhaul message that indicates for the second AP to service at least one traffic flow of a second set of traffic flows based on the second set of traffic flows being associated with a second airtime demand that is greater than the first threshold airtime availability, where the second set of traffic flows includes at least the first set of traffic flows and includes the at least one traffic flow and a remainder of the second set of traffic flows, and means for communicating, based on the backhaul message, the remainder of the second set of traffic flows with one or more client wireless communication devices of the first set of client wireless communication devices, where the remainder of the second set of traffic flows is associated with a third airtime demand that is less than or equal to the first threshold airtime availability.

Another innovative aspect of the subject matter described in this disclosure can be implemented in a non-transitory computer-readable medium storing code for wireless communications. The code may include instructions executable by one or more processors to communicate, at a first time occasion, a first set of traffic flows with a first set of client wireless communication devices, where the first set of traffic flows is associated with a first airtime demand that is less than or equal to a first threshold airtime availability associated with a communication resource configuration at the first AP, communicate, after the first time occasion and with a second AP, a backhaul message that indicates for the second AP to service at least one traffic flow of a second set of traffic flows based on the second set of traffic flows being associated with a second airtime demand that is greater than the first threshold airtime availability, where the second set of traffic flows includes at least the first set of traffic flows and includes the at least one traffic flow and a remainder of the second set of traffic flows, and communicate, based on the backhaul message, the remainder of the second set of traffic flows with one or more client wireless communication devices of the first set of client wireless communication devices, where the remainder of the second set of traffic flows is associated with a third airtime demand that is less than or equal to the first threshold airtime availability.

Some examples of the method, first APs, and non-transitory computer-readable medium described herein may further include operations, features, means, or instructions for receiving, from a set of neighbor APs, one or more reports that indicate communication link metrics associated with respective communication links between the set of neighbor APs and the first set of client wireless communication devices, where the set of neighbor APs includes the second AP, and where communicating the backhaul message may be based on a respective link metric associated with a respective communication link between the second AP and a client wireless communication of the first set of client wireless communication devices that may be associated with the at least one traffic flow satisfying a communication link metric threshold.

Some examples of the method, first APs, and non-transitory computer-readable medium described herein may further include operations, features, means, or instructions for receiving a stream classification service request message for a traffic flow from a client wireless communication device that indicate a first traffic identifier associated with the traffic flow and communicating, based on the second set of traffic flows being associated with the second airtime demand that may be greater than the first threshold airtime availability and based on respective link metrics associated with respective communication links between the set of neighbor APs and the client wireless communication device failing to satisfy the communication link metric threshold, the traffic flow in accordance with a second traffic identifier that may be associated with a lower priority than the first traffic identifier.

In some examples of the method, first APs, and non-transitory computer-readable medium described herein, the communication link metric threshold may be a latency threshold.

In some examples of the method, first APs, and non-transitory computer-readable medium described herein, the backhaul message indicates for the second AP to service one or more traffic flows associated with a first client wireless communication device of the first set of client wireless communication devices, the one or more traffic flows include the at least one traffic flow, and the one or more client wireless communication devices include a remainder of the first set of client wireless communication devices other than the first client wireless communication device.

Some examples of the method, first APs, and non-transitory computer-readable medium described herein may further include operations, features, means, or instructions for receiving, after the first time occasion, a request to add a new traffic flow, where the second set of traffic flows includes the first set of traffic flows and the new traffic flow.

In some examples of the method, first APs, and non-transitory computer-readable medium described herein, the at least one traffic flow includes the new traffic flow.

In some examples of the method, first APs, and non-transitory computer-readable medium described herein, the second set of traffic flows may be a same as the first set of traffic flows.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example of a flow control manager of an AP and an available airtime diagram that support service level agreement (SLA) traffic flow control.

FIG. 4 shows an example of a flow diagram that supports SLA traffic flow control.

FIG. 5 shows an example of a flow diagram that supports SLA traffic flow control.

FIG. 6 shows an example of a signaling diagram that supports SLA traffic flow control.

FIG. 7 shows an example of a signaling diagram that supports SLA traffic flow control.

FIG. 8 shows an example of a flow diagram that supports SLA traffic flow control.

FIG. 9 shows an example of a flow diagram that supports SLA traffic flow control.

FIG. 10 shows an example of a flow diagram that supports SLA traffic flow control.

FIG. 11 shows an example of a flow diagram that supports SLA traffic flow control.

FIG. 12 shows an example of a flow diagram that supports SLA traffic flow control.

FIG. 13 shows an example of a flow diagram that supports SLA traffic flow control.

FIG. 14 shows an example of a flow diagram that supports SLA traffic flow control.

FIG. 15 shows an example of a process flow that supports SLA traffic flow control.

FIG. 16 shows an example of a process flow that supports SLA traffic flow control.

FIG. 17 shows an example of a process flow that supports SLA traffic flow control.

FIG. 18 shows an example of a process flow that supports SLA traffic flow control.

FIG. 19 shows a block diagram of an example wireless communication device that supports SLA traffic flow control.

FIG. 20 shows a flowchart illustrating an example process performable by or at an AP that supports service level agreement traffic flow control.

FIG. 21 shows a flowchart illustrating an example process performable by or at a first AP that supports SLA traffic flow control.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, an access point (AP) may prioritize traffic flows associated with multiple client wireless communication devices (such as wireless stations (STAs)) over a same channel or bandwidth. For example, the channel or bandwidth may have a limited quantity of airtime during which the AP may service each of the traffic flows. Each traffic flow may be associated with a quality of service (QoS) characteristic which may indicate a priority and/or allowed latency for the traffic flow. For example, the QoS characteristic may be defined in a service level agreement (SLA) for the traffic flow. An SLA for a traffic flow, including the QoS parameters for the traffic flow, may be negotiated between the client wireless communication device and the AP prior to establishment of the traffic flow. Traffic flows may have different QoS parameters that may be associated with different priorities, such as based on latency demands. For example, traffic flows for extended reality type traffic or video traffic may have higher latency demands than other traffic flows such as traffic flows for web browsing. In some examples, multiple APs may operate in accordance with a mesh configuration to provide a broader coverage area. In such examples, APs in the mesh network may exchange link metric reports to indicate the link qualities between the various APs and the client wireless communication devices serviced by the mesh network. Within the mesh network, the AP that services a given client wireless communication device may be the AP with the highest link metric for that given client wireless communication device. In some examples, a client wireless communication device may request to add a new traffic flow to a channel, which may cause the total traffic demand to exceed an available airtime associated with the channel. In some examples, due to changing channel conditions (for example, due to increased overlapping basic service set (OBSS) interference), the AP may not be able to service all of the configured traffic flows on a channel in accordance with the respective QoSs/SLAs for the configured traffic flows.

Various aspects relate generally to adaptations by an AP in the event of a QoS breach for a channel or an addition of a new traffic flow to a channel that causes the airtime demand for the channel to exceed an available airtime threshold for the channel. A QoS breach also may be referred to as an SLA breach. A QoS breach may refer to a breach of a QoS parameter (such as a latency parameter) negotiated between a STA and an AP for a traffic flow. Some aspects more specifically relate to a standalone AP scenario where the AP may adjust one or more communication parameters to increase the available airtime. For example, the AP may increase transmission power to enable a higher modulation and coding scheme (MCS) and thereby reduce latency, change to a higher bandwidth channel or increase the bandwidth of the channel, increase the number of spatial streams (NSS), or devote more memory or central processing unit (CPU) resources to the channel. As another example, the AP may exit a power saving mode and enter a full power mode to support the increased traffic and/or to overcome a reduction in channel conditions that may lead to a beach of an SLA. As another example, the AP may switch to another channel with lower OBSS interference or lower OBSS dedicated airtime. In some examples, if adjusting the one or more communication parameters to increase the available airtime does not resolve the airtime demand exceeding the available airtime threshold, the AP may negotiate a lower QoS parameter (such as a lower priority or a lower latency demand) with at least one or the client wireless communication devices for a traffic flow to reduce the airtime demand. Some aspects may more specifically relate to a mesh scenario, where the AP may steer at least one client wireless communication device to another AP in the event of a QoS breach for a channel or an addition of a new traffic flow to a channel that causes the airtime demand for the channel to exceed an available airtime threshold for the channel.

Particular aspects of the subject matter described in this disclosure can be implemented to realize one or more of the following potential advantages. In some examples, by adapting communication parameters to increase the available airtime and/or to increase the amount of traffic that can be serviced within a given airtime, an AP may service a new traffic flow that would otherwise be rejected. Accordingly, more traffic may be supported. As another example, by adapting communication parameters to increase the available airtime and/or to increase the amount of traffic that can be serviced within a given airtime, lower priority traffic flows may not be dropped in the event of an SLA breach or a request to service a higher priority traffic flow, thereby reducing service interruptions. As another example, by steering a client wireless communication device to another AP in the event of a QoS breach for a channel or an addition of a new traffic flow to a channel that causes the airtime demand for the channel to exceed an available airtime threshold for the channel, service interruptions due to a QoS breach or the addition of the new traffic flow may be reduced or avoided.

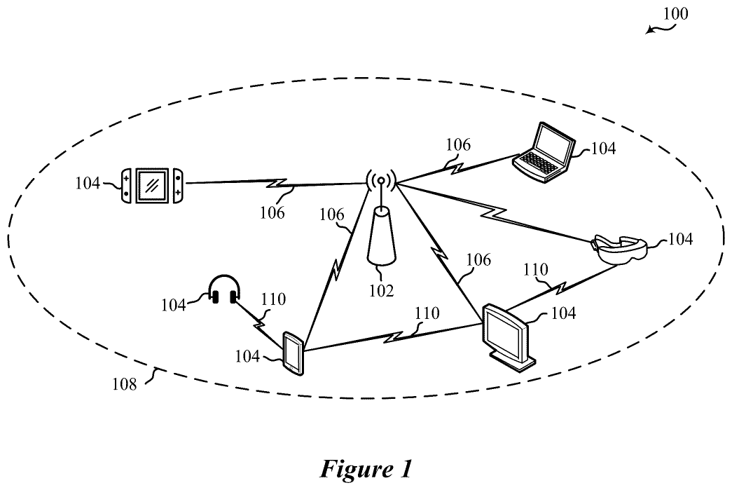

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a BSS identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client wireless communication devices and an O-Primary channel may be specifically used by non-legacy (for example, UHR- or IEEE 802.11bn-compatible) devices for opportunistic access to spectrum that may be otherwise under-utilized.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QoS) parameters.

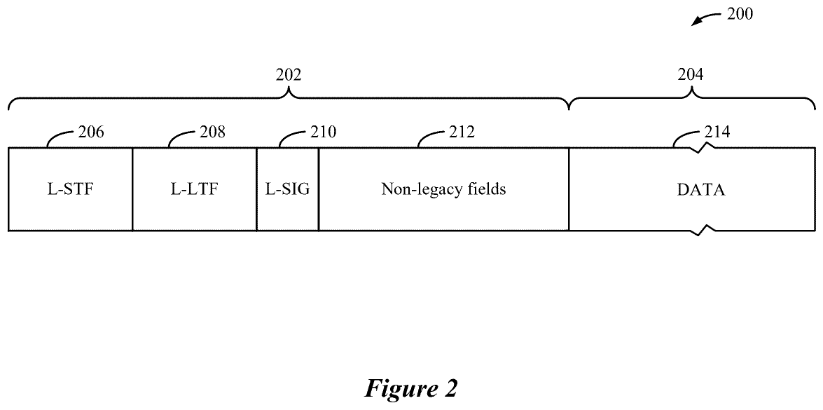

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Retransmission protocols, such as hybrid automatic repeat request (HARQ), also may offer performance gains. A HARQ protocol may support various HARQ signaling between transmitting and receiving wireless communication devices (for example, the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example, a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

APs and STAs (for example, the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased NSS (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples, supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples, supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some examples, an AI/ML model may be used for spatial reuse (SR) techniques and determinations. For example, a wireless communication device may exchange signaling to ascertain inputs to an AI/ML model and utilize an output of the AI/ML model to perform wireless communications in accordance with a SR procedure to improve the effectiveness of the SR procedure. For example, by using an AI/ML model (and in some aspects, shared observations and measurements from other devices as inputs to the AI/ML model), a transmitting device may more effectively generate SR parameters supporting SR transmissions, resulting in more effective use of available system resources, improved throughput, improved reliability, decreased latency, and better user experience. For example, a STA, an AP, or both, may use an AI/ML model to obtain one or more SR parameters, such as an overlapping BSS (OBSS) preamble detection (PD) value, or a threshold of detected interference below which the device may transmit at a lower transmit power.

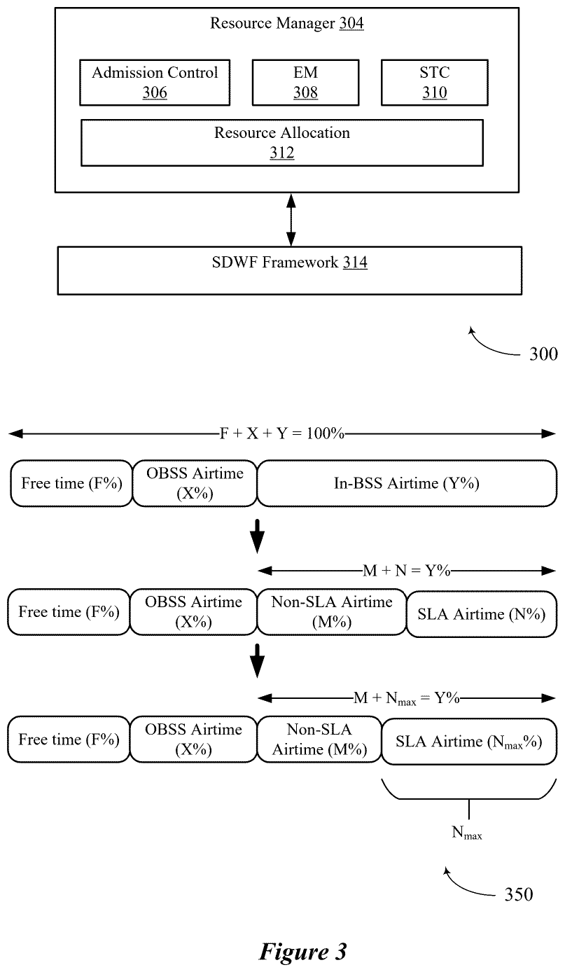

FIG. 3 shows an example of a flow control manager 300 of an AP and an available airtime diagram 350 that supports SLA traffic flow control. The flow control manager 300 of an AP and the available airtime diagram 350 may implement or may be implemented by aspects of the wireless communication network 100. For example, the flow control manager 300 may be an example of a manager at an AP 102 as described herein which manages traffic flows with one or more client devices (for example, STAs 104) of the AP 102. The available airtime diagram 350 may illustrate available airtime over a channel via which the AP communicates with the one or more client wireless communication devices.

An AP 102 may service multiple traffic flows with the one or more client devices. For example, traffic flows may involve the exchange of PDUs 200 as described with reference to FIG. 2. Service defined Wi-Fi (SDWF) may prioritize traffic flows based on rules created by: (1) user/network defined rules; (2) stream classification service (SCS) requests, which may be initiated by an STA 104; and (3) a smart traffic classifier (STC), which may be an artificial intelligence (AI) or machine learning (ML) model. For example, SCS requests may involve an SCS request from an STA 104 which requests a QoS parameter and an SCS response from the AP 102 that indicates whether the AP 102 can accept or rejects the traffic flow with the requested SCS parameter. System resources of an AP 102 (such as channel capacity, bandwidth, throughput) may be limited. As another example, the STC of the AP 102 may determine a QoS parameter for a requested traffic flow based on the type of traffic included in the traffic flow, which may be indicated in a request for service from the client wireless communication device. Prioritization requests may be received at the AP resource manager 304 from the entities above (user/network defined rules, SCS requests, and an STC manager 310). The AP resource manager 304 may include an STC manager 310 which manages classifies traffic flows, an easy mesh (EM) manager 308 which may manage communications with other APs 102, and/or a resource allocation manager 312 which may allocate resources such as bandwidth, memory and processing units of the AP 102, airtime, and/or spatial streams to different traffic flows.

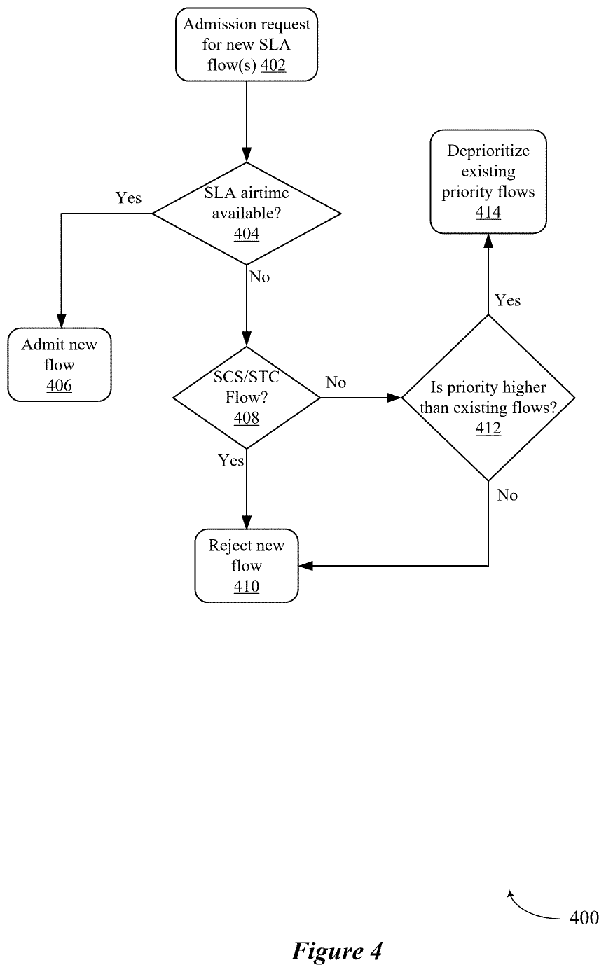

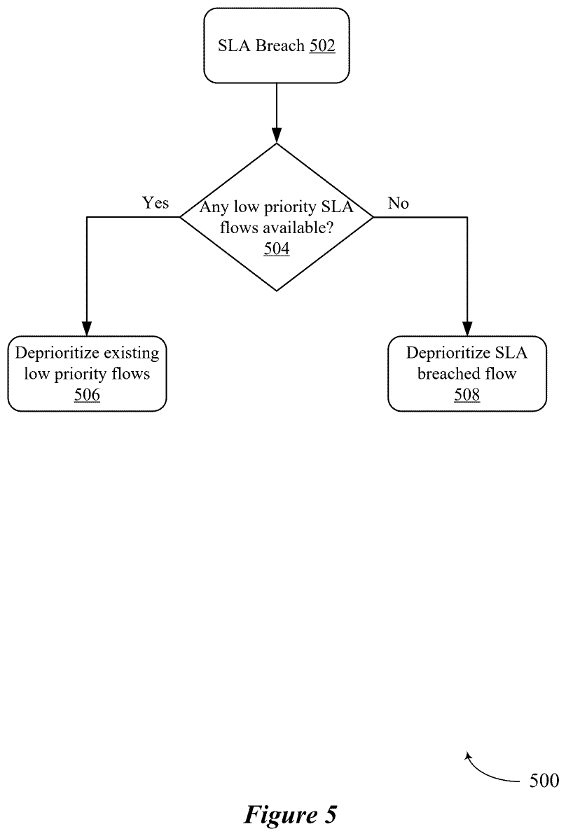

The AP 102 (for example, the AP flow control manager 300) may determine to accept or reject such requests using an SDWF admission control algorithm, which may run in the AP resource manager 304. For example, the AP 102 may be provided an SDWF framework 314 which may provide rules for admitting traffic flows, and the admission control manager 306 may manage admission traffic flows for the client wireless communication devices (such as STAs 104). For example, the admission control manager 306 may ensure that accepted requests meet the already accepted SLAs for traffic flows (for example, the admission of an additional request does not cause a breach to an already accepted SLA). The admission control manager 306 may perform processes such as described with reference to FIG. 4 and FIG. 5 in the event of SLA breaches due to lack of available airtime for the SLA traffic flow. For example, for a new requested SLA flow, the admission control manager 306 may admit the SLA flow (and add the SLA flow to the priority list of traffic flows serviced by the AP 102) if the addition of the SLA flow does not impact other prioritized flows. As another example, for a new requested SLA flow, the admission control manager 306 may admit the SLA flow (and add the SLA flow to the priority list of traffic flows serviced by the AP) and may deprioritize other traffic flow(s). As another example, if there are no traffic flows that may be deprioritized and there is insufficient airtime available to service the new traffic flow (for example, and the new traffic flow is a lower priority than existing traffic flows) the admission control manager 306 may reject the SLA flow.

As shown in the available airtime diagram 350, an AP 102 may have a total available airtime for a given channel that includes a percentage of free time F, a percentage of free time used by other BSSs (for example, OBSS time X), and a percentage of time used by the BSS of the AP 102 (Y), where F+X+Y=100. A new SLA flow may may demand an airtime of Q, which may be indicated in a request for the new SLA flow from the STA 104 or may be determined based on QoS parameters indicated in the request for the new SLA flow and the current channel conditions. In BSS airtime Y may be split into airtime for SLA flows, N, and airtime for non-SLA flows, M. Non-SLA traffic flows may refer to traffic flows serviced by the AP that are not subject to an SLA negotiated with a client wireless communication device. For example, a non-SLA traffic flow may not have a defined QoS parameter. N may be capped at Nₘₐₓ, which may be, for example, 90%. Accordingly, a new SLA may be admitted, for example, if the available SLA airtime is greater than Q.

FIG. 4 shows an example of a flow diagram 400 that shows a process an AP 102 may implement in the event of a request for a new SLA flow. The flow diagram 400 may implement or may be implemented by aspects of the wireless communication network 100 flow control manager 300.

At 402, an AP 102 as described herein may receive an admission request for a new SLA flow. At 404, the AP 102 (for example, the flow control manager 300 of the AP 102 as described with reference to FIG. 3) may determine if SLA airtime is available for the new SLA flow. For example, with reference to the available airtime diagram 350 of FIG. 3, if the new SLA flow has an airtime requirement of Q to meet the QoS demand associated with the new SLA flow, the already admitted SLA flows have an airtime demand of N, and the maximum SLA airtime is Nₘₐₓ, the new SLA flow may be admitted at 406 if Q<Nₘₐₓ−N. If SLA airtime is not available at 404 for the new SLA flow (for example, if Q>Nₘₐₓ−N), at 408 the AP 102 may determine whether the new SLA flow is an SCS or STC flow (for example, requested in accordance with an SCS request from an STA 104 or from the STC of the AP 102). If at 408 the AP 102 determines that the new SLA flow is an SCS or STC flow, at 410 the AP 102 (for example, the AP resource manager 304) may reject the new SLA flow (and the new SLA flow may be moved to other flows with background traffic). If at 408 the AP 102 determines that the new SLA flow is an SCS or STC flow, at 412 the AP 102 may determine whether the priority of the new SLA flow is higher than the existing SLA flows. If at 412 the AP 102 determines the priority of the new SLA flow is not higher than the existing SLA flows, at 410 the AP 102 may reject the new flow (and the new SLA flow may be moved to other flows with background traffic). As described herein, priorities of SLA traffic flows may be kept in a priority list at the AP 102 and may be based on QoS parameters indicated by the respective SLAs. If 412 the AP 102 determines the priority of the new SLA flow is higher than the one or more existing SLA flows, at 414 the AP 102 may deprioritize the one or more existing SLA flows and may admit the new SLA flow.

FIG. 5 shows an example of a flow diagram 500 that shows a process an AP 102 may implement in the event of an SLA breach. The flow diagram 500 may implement or may be implemented by aspects of the wireless communication network 100 flow control manager 300. An SLA breach may occur, for example, when OBSS airtime (X in FIG. 3) increases, reducing the amount of in-BSS airtime (Y in FIG. 3), or when channel conditions deteriorate, decreasing the amount of data that can be transmitted in the available airtime.

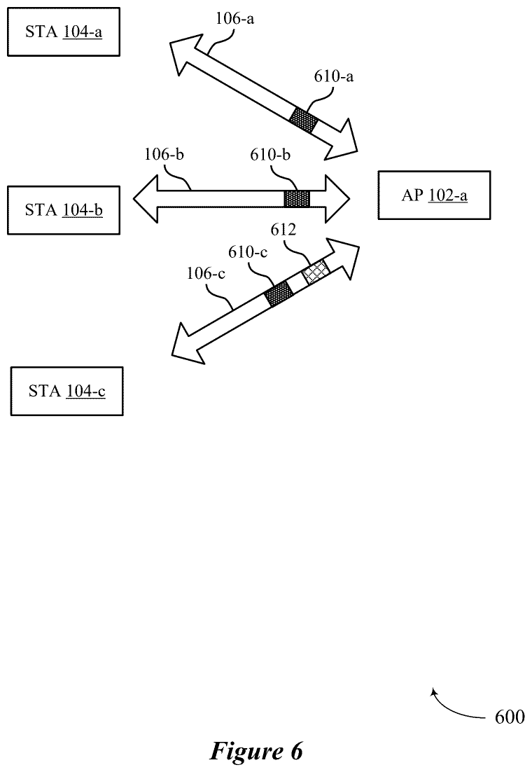

At 502, the AP 102 may identify an SLA breach. For example, the AP 102 may identify that a latency requirement associated with a traffic flow as defined in the QoS parameter of an SLA for the SLA flow that is breached cannot be in the communications parameters for a channel on which the SLA flow is communicated. At 504, the AP (for example, the AP resource manager 304) may identify if any lower priority SLA flows are available (for example, lower priority than the breached SLA flow). If at 504 the AP 102 identifies that any lower priority SLA flows are available, at 506 the AP 102 may deprioritize the lower priority SLA flows. If at 504 the AP 102 identifies that no lower priority SLA flows are available, at 508 the AP 102 may deprioritize the breached SLA flow. In some examples, as described herein, the AP may examine opportunities for resource expansion to mitigate the breach without impacting existing SLA flows. For example, deprioritizing SLA flows may be a worst case consideration. The SDWF admission control of the AP 102 may analyze the network and attempt communication parameter optimizations and/or client steering, as described with reference to FIGS. 6-14 to avoid SLA breaches.

FIG. 6 shows an example of a signaling diagram 600 that supports SLA traffic flow control. The signaling diagram 600 may implement or may be implemented by aspects of the wireless communication network 100 or the PDU 200. For example, the signaling diagram 600 may include an AP 102-a, which may be an example of an AP 102 as described herein. The AP 102-a may communicate with one or more STAs 104 via one or more communication links 106.

For example, the AP 102-a may communicate a traffic flow 610-a with an STA 104-a via a communication link 106-a, the AP 102-a may communicate a traffic flow 610-b with an STA 104-b via a communication link 106-b, and the AP 102-a may communicate a traffic flow 610-c with an STA 104-c via a communication link 106-c. For example, the traffic flows 610 may involve the communication of PDUs 200 as described herein.

The AP 102-a may include a resource manager (for example, an AP resource manager 304 as described herein) and may analyze the network that include the AP 102-a and the STAs 104 to reduce SLA breaches and/or accommodate new SLA flows. For example, at a first time occasion, the AP 102-a may communicate the traffic flow 610-a with the STA 104-a and the traffic flow 610-b with the STA 104-b on a communication channel (for example, a frequency band). The AP 102-a may communicate the traffic flow 610-a and the traffic flow 610-b in accordance with a first communication resource configuration associated with a first threshold airtime availability. For example, the first resource configuration may include one or more of a transmission power level, an amount of memory of the AP 102-a, an amount of CPU resources of the AP 102-a, a bandwidth of the channel, and/or an NSS. The threshold airtime availability may correspond to a first value of N as described with reference to FIG. 3, and may be referred to as N₁.

In some examples, after the first time occasion, the STA 104-c may send a request 612 to add the traffic flow 610-c. Addition of the traffic flow 610-c may increase the airtime demand of the traffic flow 610-a, the traffic flow 610-b, and the traffic flow 610-c above N₁ (the threshold airtime availability associated with the first communication resource configuration). In some examples, to admit the traffic flow 610-c in response to the request 612, the AP 102-a may adjust one or more communication parameters in order to communicate at a second time occasion in accordance with a second communication resource configuration associated with a second threshold airtime availability, N₂, where N₂ is greater than N₁. More data may be communicated over a same time period or more time may be available to communicate the traffic flows 610 in accordance with the second communication resource configuration than the first communication resource configuration. For example, the second communication resource configuration may have a larger bandwidth, more dedicated memory of the AP 102-a, more dedicated CPU resources of the AP 102-a, a higher NSS, and increase MCS, and/or a higher transmission power. If the adjustment of the communication parameters does not allow for the admittance of the traffic flow 610-c, the AP 102-a may perform an SLA reprioritization or an SLA renegotiation as described herein with the STA 104-c. In some examples, the AP 102-a may adjust communications parameters serially, and may be configured to wait a back off time after adjusting the one or more communication parameters prior to adjusting one or more additional communication parameters in order to allow the system to stabilize (for example, to avoid adjustment of communication parameters that may increase power usage or interference if less intrusive adjustments may resolve the airtime demand). For example, the AP 102-a may first adjust an amount of memory or CPU resources of the AP 102-a and may wait a back off time after adjusting the amount of memory or CPU resources of the AP 102-a in order to allow the system to stabilize before adjusting the bandwidth. Accordingly, the AP 102-a may avoid performing more extreme or power-intensive adjustments unless less invasive adjustments fail to enable the new traffic flow to be admitted.

As another example, at the first time occasion, the AP 102-a may communicate the traffic flow 610-a with the STA 104-a, the traffic flow 610-b with the STA 104-b, and the traffic flow 610-c with the STA 104-c on a communication channel. in accordance with a first communication resource configuration associated with a first threshold airtime availability. After the first time occasion, an SLA breach may occur. or the AP 102-a may determine that an SLA breach may occur absent adjustment of communication parameters (for example, the AP 102-a may be unable to satisfy the QoS for the traffic flow 610-c due to changing channel conditions). In response to the SLA breach, or in response to the AP 102-a determining that an SLA breach is likely to occur, the AP 102-a may may adjust one or more communication parameters in order to communicate at a second time occasion in accordance with a second communication resource configuration associated with a second threshold airtime availability, N₂, where N₂ is greater than N₁. Accordingly, the AP 102-a may avoid or mitigate the SLA breach. If the adjustment of the communication parameters does not mitigate the SLA breach of the traffic flow 610-c, the AP 102-a may perform an SLA reprioritization or an SLA renegotiation with the STA 104-c. As described herein, in some examples, the AP 102-a may adjust communications parameters serially, and may be configured to wait a back off time after adjusting the one or more communication parameters prior to adjusting one or more additional communication parameters in order to allow the system to stabilize (for example, to avoid adjustment of communication parameters that may increase power usage or interference if less intrusive adjustments may resolve the SLA breach).

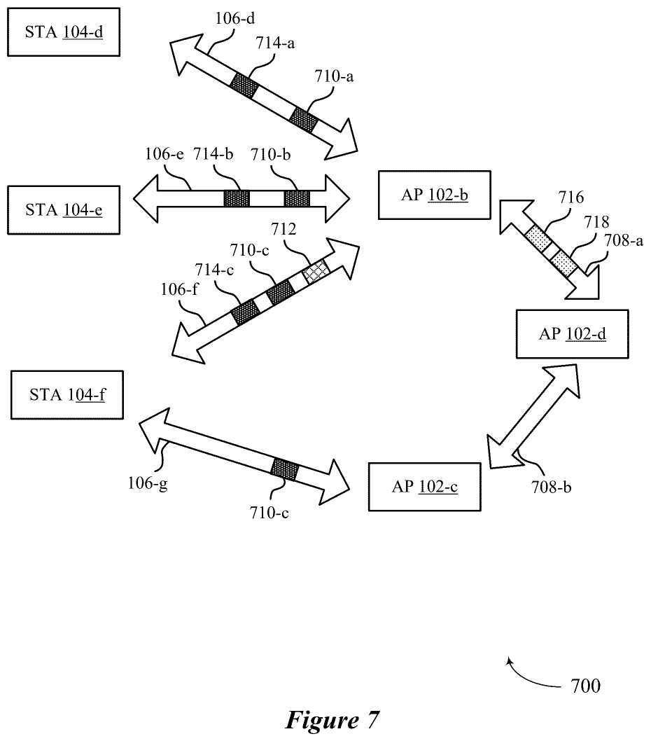

FIG. 7 shows an example of a signaling diagram 700 that supports SLA traffic flow control. The signaling diagram 700 may implement or may be implemented by aspects of the wireless communication network 100 or the PDU 200. For example, the signaling diagram 700 may include an AP 102-b, and AP 102-c, and an AP 102-d, which may be examples of an AP 102 as described herein. The AP 102-b may communicate with one or more STAs 104 via one or more communication links 106. The STAs 104 may be examples of STAs 104 as described herein.

For example, the AP 102-b may communicate a traffic flow 710-a with an STA 104-d via a communication link 106-d, the AP 102-b may communicate a traffic flow 710-b with an STA 104-e via a communication link 106-e, and the AP 102-b may communicate a traffic flow 710-c with an STA 104-f via a communication link 106-f. For example, the traffic flows 710 may involve the communication of PDUs 200 as described herein. The AP 102-b may communicate with the AP 102-d via a communication link 708-a, and the AP 102-d may communicate with the AP 102-c via a communication link 708-b. For example, the APs 102 may be arranged in a mesh network. For example, the communication links 708 may be backhaul links. In some examples, the AP 102-b and the AP 102-c may be AP agents of the mesh network, and the AP 102-d may be an AP controller of the mesh network.

The STAs 104 may measure reference signals or other signals transmitted the APs 102 in the mesh network and may provide link metrics reports 714 to the AP 102-b based on the measurements of the reference signals or other signals. For example, the STAs 104 may measure beacons or pilot signals transmitted by the APs 102. In some examples, the AP 102-b may request the link metrics reports 714 for the STAs 104. For example, the link metric reports may indicate signal to noise ratio (SNR) values or received signal strength indicator (RSSI) values that are generated based on measurements of the reference signals or other signals transmitted by the APs 102. For example, the link metrics report 714-a may indicate a channel metric for the communication link 106-d and a communication link between the AP 102-c and the STA 104-d, the link metrics report 714-b may indicate a channel metric for the communication link 106-e and a communication link between the AP 102-c and the STA 104-e, and the link metrics report 714-c may indicate a channel metric for the communication link 106-f and a communication link between the AP 102-c and the STA 104-f. The APs 102 within the mesh network may exchange link metrics reports 714 with the other APs 102 of the mesh network for the different communications links, for example, based on the link metrics reports 714 provided by the STAs 104. For example, the AP 102-b may provide a link metrics report 718 to the AP 102-d based on the link metrics reports 714. In some examples, the AP 102-d may provide a link metrics report to the AP 102-c based on the link metrics report 718. In some examples, the AP 102-c may provide a link metric report to the AP 102-b for one or more STAs 104 serviced by the AP 102-c. Accordingly, within the mesh network each STA 104 may have information regarding link metrics to the AP 102 to which each STA 104 is connected and one or more neighbor APs. The APs 102 also may have the link metric information for the neighbor APs for the given STAs 104.

In a mesh network, each STA 104 may be connected to the AP 102 of the mesh network with the best channel metric (such as the highest RSSI and/or the connection that allowed for the highest MCS or throughput) for that STA 104. For example, the STA 104-d, the STA 104-e, and the STA 104-f may each be connected to the AP 102-b because the STA 104-d, the STA 104-e, and the STA 104-f may have better link metrics (for example, higher SNR or RSSI) with the AP 102-b than the AP 102-c and/or the AP 102-d. For example, Table 1 shows an example of MCSs that may be supported at different SNRs at different maximum NSSs.

TABLE 1
SNR based on Max NSS

| MCS | 1 | 2 | 3 | 4 |
|---|---|---|---|---|
| 0 | −4 | 0 | 1 | 3 |
| 1 | −1 | 3 | 5 | 7 |
| 2 | 2 | 5 | 8 | 10 |
| 3 | 4 | 8 | 11 | 15 |
| 4 | 8 | 12 | 15 | 18 |
| 5 | 12 | 16 | 20 | 25 |
| 6 | 14 | 18 | 21 | 26 |
| 7 | 15 | 19 | 23 | 27 |
| 8 | 19 | 23 | 27 | 32 |
| 9 | 21 | 25 | 29 | 34 |
| 10 | 24 | 28 | 32 | 39 |
| 11 | 26 | 30 | 34 | 40 |

The AP 102-b may include a resource manager (for example, an AP resource manager 304 as described herein) and may analyze the network that includes the AP 102-b and the STAs 104 to reduce SLA breaches and/or accommodate new SLA flows. For example, at a first time occasion, the AP 102-b may communicate the traffic flow 710-a with the STA 104-d and the traffic flow 710-b with the STA 104-e on a communication channel. The AP 102-b may communicate the traffic flow 710-a and the traffic flow 710-b in accordance with a first communication resource configuration associated with a threshold airtime availability. The threshold airtime availability may correspond to a first value of N as described with reference to FIG. 3.

In some examples, after the first time occasion, the STA 104-f may send a request 712 to add the traffic flow 710-c. Addition of the traffic flow 710-c may increase the airtime demand of the traffic flow 710-a, the traffic flow 710-b, and the traffic flow 710-c above N₁ (for example, the threshold airtime availability associated with the first communication resource configuration). In some examples, to admit the traffic flow 710-c in response to the request 712, the AP 102-b may steer the STA 104-f to the AP 102-c even though the communication link 106-g between the STA 104-f and the AP 102-c supports a lower MCS (for example, has a worse link quality than) the communication link 106-f between the STA 104-f and the AP 102-b. The communication link 106-g may not have a rate v range (RvR) that guarantees a highest MCS, but may provide better latency than the communication link 106-f due to the load on the AP 102-b from the other traffic flows 710. For example, the AP 102-b may steer the STA 104-f to the AP 102-c if such steering would satisfy a latency demand associated with the traffic flow 710-c (such as defined as a QoS parameter in an SLA for the traffic flow 710-c). Similarly, the AP 102-b may steer the STA 104-f to the AP 102-c in the case of an SLA breach of the traffic flow 710-c (or an SLA breach of the traffic flow 710-a or the traffic flow 710-b if steering the traffic flow 710-c is more beneficial in terms of latency than steering the traffic flow 710-a or the traffic flow 710-b). Accordingly, even if a STA 104 is initially connected for the best PHY rates, in the absence of an SLA guarantee, the APs 102 may steer an STA 104 to an AP 102 with a lower PHY rate but a guarantee of satisfying the SLA for the traffic flow(s) for the STA 104.

To steer the STA 104-f to the AP 102-c, the AP 102-b may send a backhaul message 716 to the AP 102-c (for example, either directly or via the AP 102-d) that indicates for the AP 102-c to service the traffic flow 710-c of the STA 104-f. The AP 102-c may perform a connection establishment procedure with the STA 104-f based on the backhaul message 716 and may service the traffic flow 710-c.

In some examples, the AP 102-b may first attempt to adjust communication parameters, as described with reference to FIG. 6 to accommodate the traffic flow 710-c before steering the STA 104-f to the AP 102-c. 404.

In some examples, if an STA 104 is a boundary edge STA (for example, located at an edge of the area serviced by the mesh network), steering the STA to another AP 102 may not be beneficial due to link metrics. For example, if the traffic flow 710-a has an SLA breach, and the link metrics for the STA 104-d and the AP 102-c and the AP 102-d are not sufficient to satisfy a latency demand of the SLA for the traffic flow 710-a, the AP 102-b may not steer the STA 104-d to another AP 102. In such cases, the AP 102-b may perform SLA negotiations with the STA 104-d to admit the traffic flow 710-a into a lower traffic identifier (TID). For example, the STA 104-d and the AP 102-b may exchange SCS requests and responses to negotiate a lower priority TID.

If the communication links 708 are wired links (for example, ethernet links), the front haul links (the links between APs 102 and STAs 104) may be able to operate on independent channels across the mesh network and thus reduce OBSS interference from the controller and agent APs, which may reduce the latency in the system of the mesh network and aid in steering decisions as client wireless communication devices (such as STAs 104) may be moved across different APs with different channels having lower latency due to the lower OBSS airtime and interference. In a wired backhaul system, there may be no hop latency as there may be no hops across nodes of the mesh network. In a wired backhaul mesh network, steering decisions may be made purely on the bases of IBSS airtime and OBSS airtime at the controller AP/agent AP and link metrics between the APs 102 and the STAs 104. For example, the SLA and non-SLA traffic flows may be steered across the APs of the mesh network based on link metric information. In some examples, steering decisions may be decentralized in each AP of the mesh network. For example, where the AP 102-b is an AP agent, the AP 102-b may autonomously perform a steering decision for the STA 104-f. In some examples, steering decisions may be performed centrally for the mesh network (such as by the AP controller), where each AP 102 may provide link metric reports and airtime availability reports and SLA demands to the AP controller.

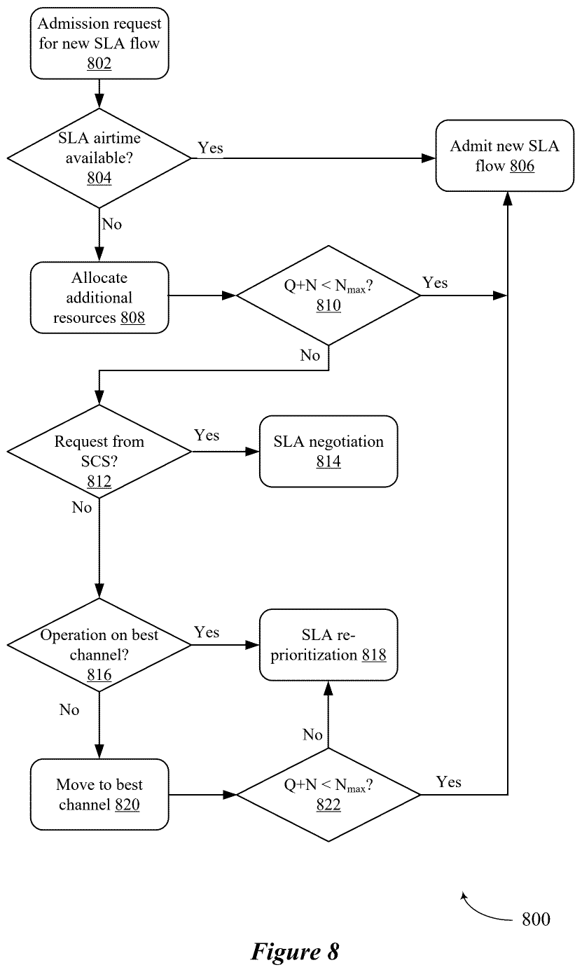

FIG. 8 shows an example of a flow diagram 800 that supports SLA traffic flow control. The flow diagram 800 may implement or may be implemented by aspects of the wireless communication network 100 or the signaling diagram 600. For example, the flow diagram 800 may be implemented by an AP 102-a of the signaling diagram 600 in the event of a request for a new SLA flow from a client wireless communication device such as an STA 104.

At 802, the AP 102 may receive a request for admission of a new SLA flow. At 804, the AP 102 (for example, the flow control manager 300 of the AP 102 as described with reference to FIG. 3) may determine if SLA airtime is available for the new SLA flow. For example, with reference to the available airtime diagram 350 of FIG. 3, if, at 804, the new SLA flow has an airtime requirement of Q to meet the QoS demand associated with the new SLA flow, the already admitted SLA flows have an airtime demand of N, and the maximum SLA airtime is Nₘₐₓ, the new SLA flow may be admitted at 806 if Q<Nₘₐₓ−N.

If SLA airtime is not available at 804 for the new SLA flow (for example, if Q>Nₘₐₓ−N), at 408 the AP 102 may adjust communication resources and/or allocated additional resources (such as memory, CPU, operating bandwidth, NSS) to increase Nₘₐₓ and/or the throughput available in Nₘₐₓ. In some examples, at 808, the AP 102 may exit a power saving mode and may instead operate in a full power mode. For example, to exit the power saving mode, the AP 102 may increase transmission power. As another example, the AP 102 may switch from operation on a 160 MHz channel to operation on a 320 MHz channel, which may allow for more available airtime (to increase Nₘₐₓ). In some examples, if addition of bandwidth does not increase available airtime, the AP 102 may not increase the bandwidth.

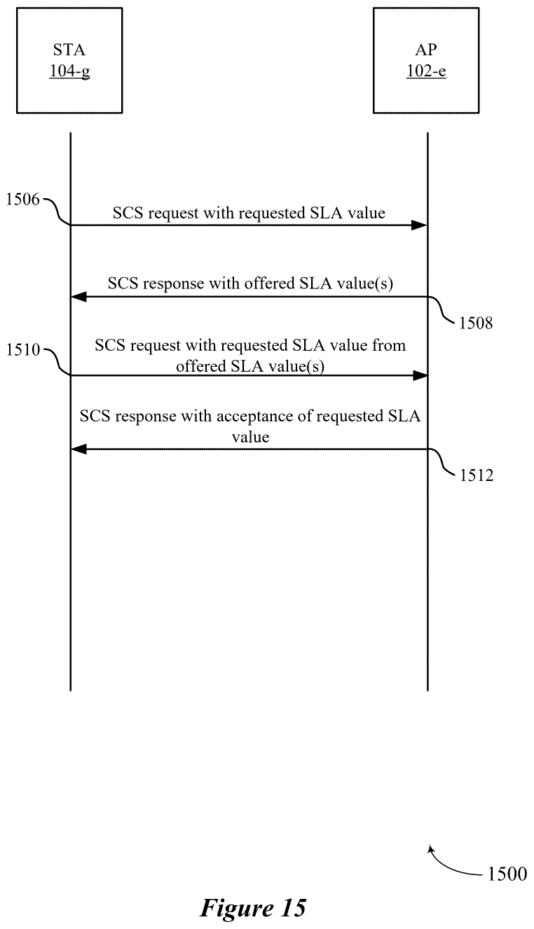

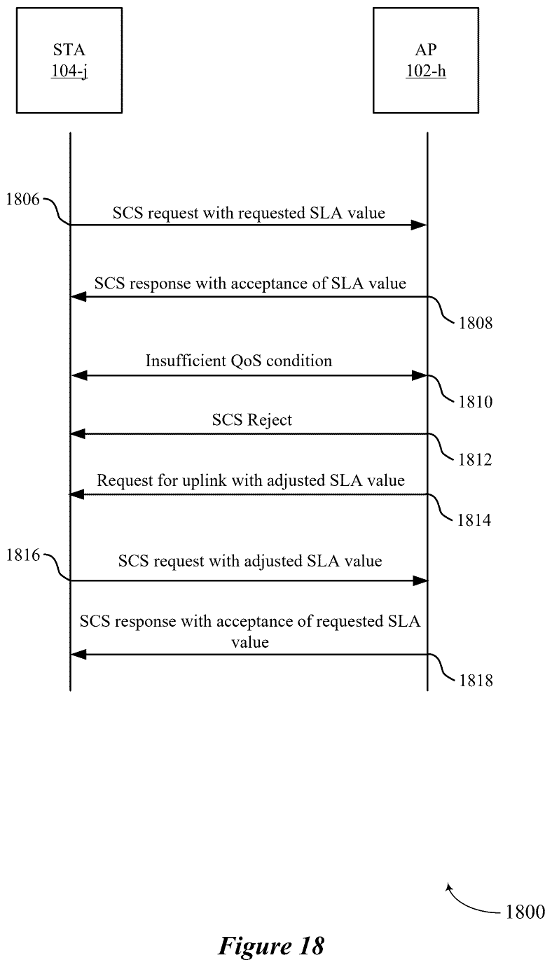

After adjusting the communications parameters at 808, at 810 the AP 102 may check if Q+N<Nₘₐₓ with the adjusted communication parameters. If at 810 with the adjusted communication parameters, Q+N<Nₘₐₓ, at 806 the new SLA flow may be admitted. If at 810 with the adjusted communication parameters, Q+N is not less than Nₘₐₓ, at 812 the AP 102 may determine whether the new SLA flow is received from an SCS request. If the new SLA flow is received from an SCS request, at 814, the AP 102 may perform an SLA negotiation with the client wireless communication device as described with reference to FIG. 15 or 18.

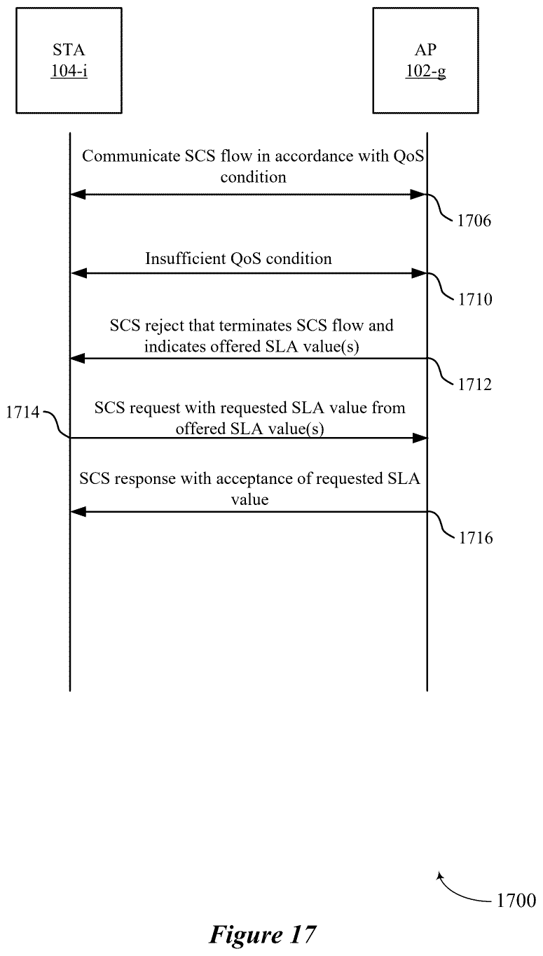

If the new SLA flow is not received from an SCS request, and if increasing the bandwidth, CPU resources, memory, transmission power, and/or NSS does not increase the available airtime (for example, increase Nₘₐₓ), at 816 the RM of the AP 102 may check if the AP 102 is operating on the best channel based on current conditions (for example, the channel with least interference from OBSS or the least airtime dedicated to OBSS (X in FIG. 3)). If the AP is on the best channel based on current conditions, at 818 the AP 102 may perform an SLA re-prioritization as described with reference to FIG. 17. If not, at 820, the AP 102 may move to the channel with the best conditions (for example, the lowest OBSS interference from OBSS or the least airtime dedicated to OBSS). After moving to the best channel at 820, at 822 the AP 102 may check if Q+N<Nₘₐₓ with the adjusted communication parameters on the different channel. If at 822, with the adjusted communication parameters and on the different channel, Q+N<Nₘₐₓ, at 806 the new SLA flow may be admitted. If at 822 with the adjusted communication parameters and on the different channel, Q+N is not less than Nₘₐₓ, at 818 the AP 102 may perform an SLA re-prioritization as described with reference to FIG. 17.

Accordingly, for a new SLA request, if the AP is not able to admit the new flow using the adjusted communication parameters and/or changing the operating channel, the AP 102 may negotiate with the client wireless communication device to lower the TID of the new SLA flow in a prioritized queue instead of a complete rejection, which may involve moving the new SLA flow to a non-priority request or performing an SLA negotiation for requests originating via SCS or STC. For example, lowering the TID may correspond to reducing the priority of the SLA flow in the queue/list of SLA flows serviced by the AP 102.

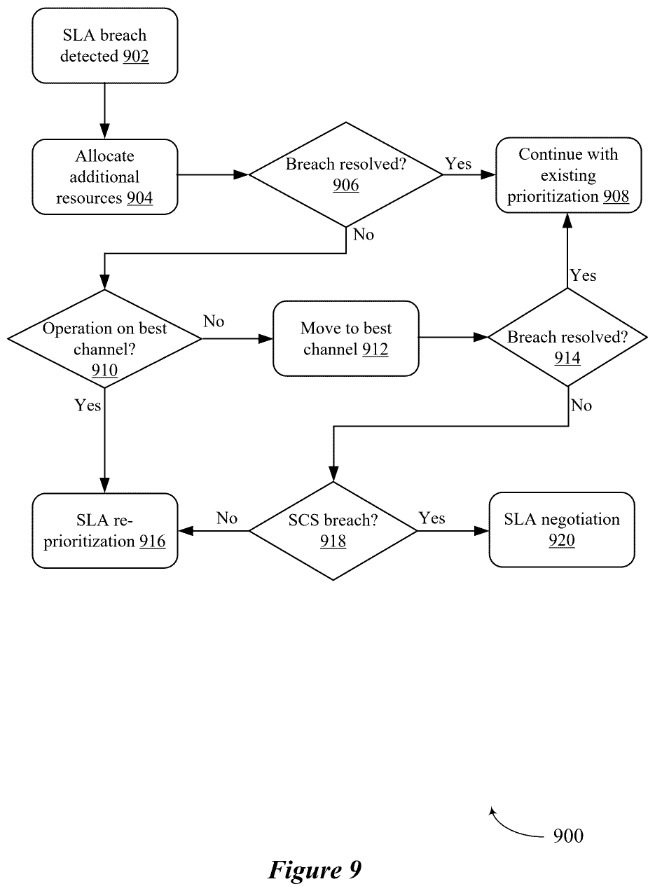

FIG. 9 shows an example of a flow diagram 900 that supports SLA traffic flow control. The flow diagram 900 may implement or may be implemented by aspects of the wireless communication network 100 or the signaling diagram 600. For example, the flow diagram 900 may be implemented by an AP 102-a of the signaling diagram 600 in the event of a request for a new SLA flow from a client wireless communication device such as an STA 104.

At 902, the AP 102 may detect an SLA breach for a traffic flow. For example, the airtime demand N of the admitted SLA flows may be greater than the threshold available airtime Nₘₐₓ for the SLA flows at the current communication resource configuration of the AP 102 (for example, of the current communication parameters). At 904, the AP 102 may adjust communication resources and/or allocated additional resources (such as memory, CPU, operating bandwidth, NSS) to increase Nₘₐₓ and/or the throughput available in Nₘₐₓ. In some examples, at 904, the AP 102 may exit a power saving mode and may instead operate in a full power mode. For example, to exit the power saving mode, the AP 102 may increase transmission power. As another example, the AP 102 may switch from operation on a 160 MHz channel to operation on a 320 MHz channel, which may allow for more available airtime (for example, increase Nₘₐₓ). In some examples, if addition of bandwidth does not increase available airtime, the AP 102 may not increase the bandwidth.

After adjusting the communications parameters at 904, at 906 the AP 102 may check if the breach is resolved (for example, if N<Nₘₐₓ with the adjusted communication parameters). If at 906 with the adjusted communication parameters, the breach is resolved (N<Nₘₐₓ), at 908 the AP 102 may continue with the adjusted communication parameters.

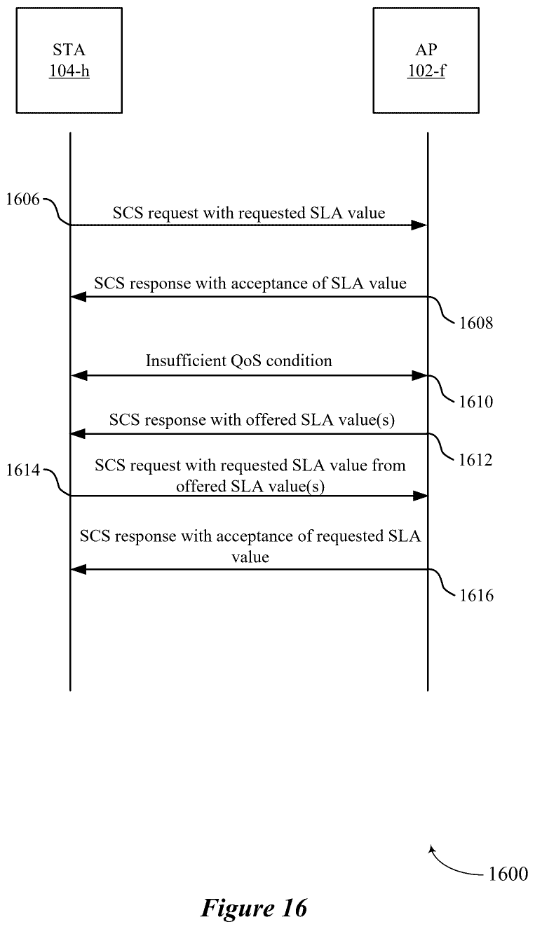

If at 906 the breach was not resolved (for example, N is not less than Nₘₐₓ with the adjusted communication parameters), at 910 the RM of the AP 102 may check if the AP 102 is operating on the best channel based on current conditions (for example, the channel with least interference from OBSS or the least airtime dedicated to OBSS (X in FIG. 3)). If the AP 102 is on the best channel based on current conditions, at 916 the AP 102 may perform an SLA re-prioritization as described with reference to FIG. 17 for the breached SLA flow. If not, at 912, the AP 102 may move to the channel with the best conditions (for example, the lowest OBSS interference from OBSS or the least airtime dedicated to OBSS. After moving to the best channel at 912, at 914 the AP 102 may check if the breach is resolved (for example, if N<Nₘₐₓ with the adjusted communication parameters on the different channel). If at 914, with the adjusted communication parameters and on the different channel the breach is resolved, at 908 the AP 102 may continue with the adjusted communication parameters. If at 914 with the adjusted communication parameters and on the different channel, the breach is not resolved, at 918 the AP 102 may determine whether the breached SLA flow was established via an SCS request. If the breached SLA flow was established via an SCS request, at 920, the AP 102 may perform an SLA negotiation with the client wireless communication device as described with reference to FIG. 16. If the breached SLA flow was not established via an SCS request, at 916, the AP 102 may perform an SLA re-prioritization as described with reference to FIG. 17 for the breached SLA flow.

Accordingly, for a breached SLA flow, if the AP 102 is not able to resolve the SLA breach using the adjusted communication parameters and/or changing the operating channel, the AP 102 may negotiate with the client wireless communication device to lower the TID of the breached SLA flow in a prioritized queue instead of a complete rejection, which may involve moving the new SLA flow to a non-priority request or performing an SLA negotiation for requests originating via SCS or STC.

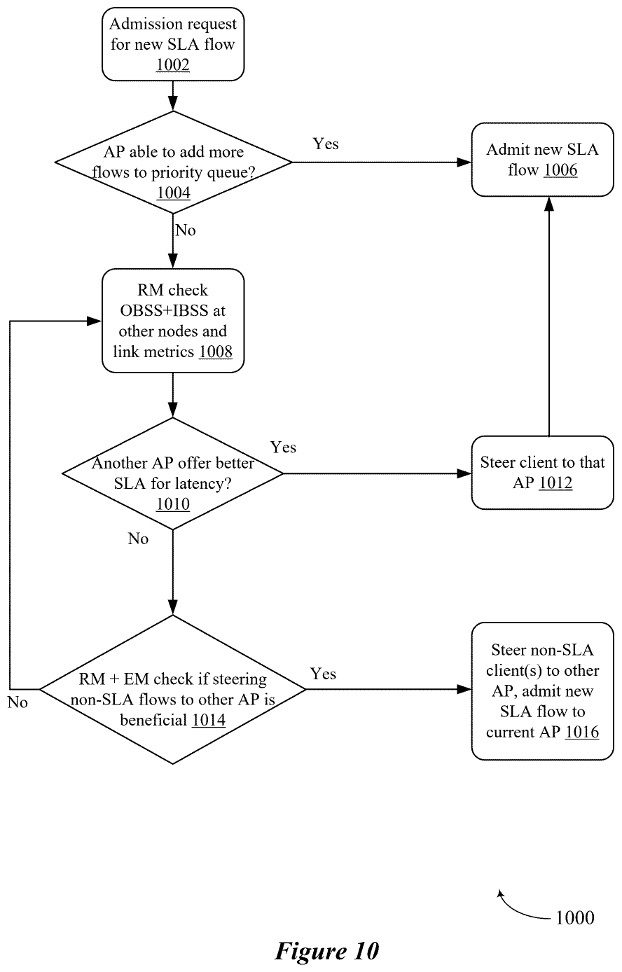

FIG. 10 shows an example of a flow diagram 1000 that supports SLA traffic flow control. The flow diagram 1000 may implement or may be implemented by aspects of the wireless communication network 100 or the signaling diagram 700. For example, the flow diagram 1000 may be implemented by an AP 102-b of the signaling diagram 700 in the event of a request for a new SLA flow from a client wireless communication device such as an STA 104.

At 1002, the AP 102 may receive a request for admission of a new SLA flow. At 1004, the AP 102 (for example, the flow control manager 300 of the AP 102 as described with reference to FIG. 3) may determine if SLA airtime is available for the new SLA flow. For example, with reference to the available airtime diagram 350 of FIG. 3, if the new SLA flow has an airtime requirement of Q to meet the QoS demand associated with the new SLA flow, the already admitted SLA flows have an airtime demand of N, and the maximum SLA airtime is Nₘₐₓ, the new SLA flow may be admitted at 1006 if Q<Nₘₐₓ−N.

If SLA airtime is not available at 1004 for the new SLA flow (for example, if Q>Nₘₐₓ−N), at 1008 the RM of the AP 102 may check the OBSS and the IBSS available airtime and the link metrics at the other nodes (the other APs 102) of the mesh network. At 1010, the AP 102 may determine whether another AP 102 of the mesh network offers a better SLA for latency for the new SLA flow. If at 1010 the AP 102 determines that another AP 102 of the mesh network offers a better SLA for latency for the new SLA flow, at 1012 the AP 102 may steer the client wireless communication device to the other AP 102, and at 1006 the new SLA flow may be admitted to the network via the other AP 102. If at 1010 the AP 102 determines that no other AP 102 of the mesh network offers a better SLA for latency for the new SLA flow, at 1014 the AP 102 may check if steering non-SLA traffic flows serviced by the AP 102 is beneficial (for example, would allow for service of the non-SLA traffic flows and admittance of the new SLA flow). If at 1014 the AP 102 determines that steering non-SLA traffic flows serviced by the AP 102 is beneficial, at 1016 the AP 102 may steer the non-SLA traffic flows to the other AP and may admit the new SLA flow. If at 1014 the AP 102 determines that steering non-SLA traffic flows serviced by the AP 102 is not beneficial, the AP 102 may return to 1008 to check the OBSS and the ISS available airtime and the link metrics at the other nodes (the other APs 102) of the mesh network.

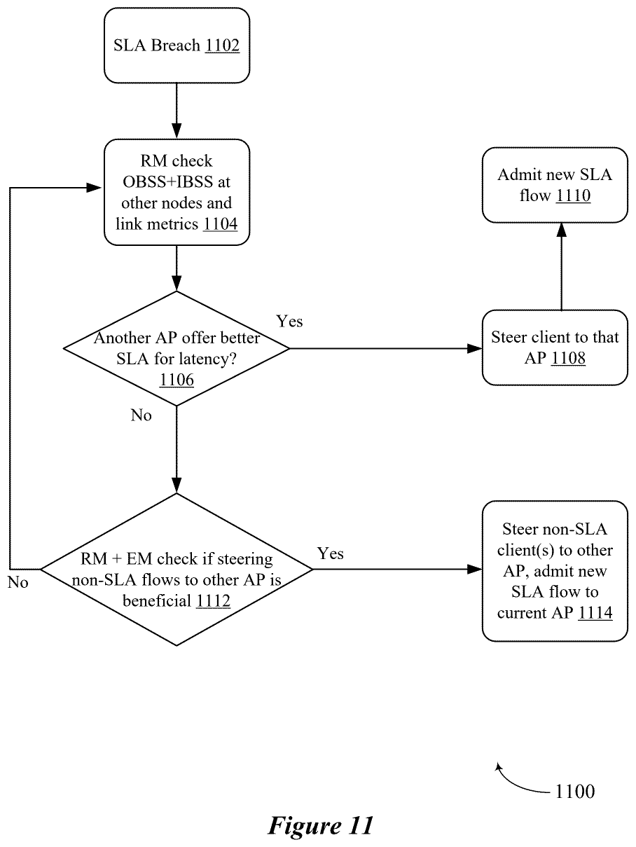

FIG. 11 shows an example of a flow diagram 1100 that supports SLA traffic flow control. The flow diagram 1100 may implement or may be implemented by aspects of the wireless communication network 100 or the signaling diagram 700. For example, the flow diagram 1100 may be implemented by an AP 102-b of the signaling diagram 700 in the event of an SLA breach from a client wireless communication device such as an STA 104.

At 1102, the AP 102 may detect an SLA breach for a traffic flow. For example, the airtime demand N of the admitted SLA flows may be greater than the threshold available airtime Nₘₐₓ for the SLA flows at the current communication resource configuration of the AP 102 (for example, of the current communication parameters).

At 1104, in response to the SLA breach at 1102, the RM of the AP 102 may check the OBSS and the IBSS available airtime and the link metrics at the other nodes (the other APs 102) of the mesh network. At 1106, the AP 102 may determine whether another AP of the mesh network offers a better SLA for latency for the breached SLA flow. If at 1106 the AP 102 determines that another AP 102 of the mesh network offers a better SLA for latency for the breached SLA flow, at 1108 the AP 102 may steer the client wireless communication device to the other AP 102, and at 1110 the breached SLA flow may be admitted to the network via the other AP 102. If at 1106 the AP 102 determines that no other AP 102 of the mesh network offers a better SLA for latency for the breached SLA flow, at 1112 the AP 102 may check if steering non-SLA traffic flows serviced by the AP 102 is beneficial (for example, would allow for service of the non-SLA traffic flows and admittance of the new SLA flow). If at 1112 the AP 102 determines that steering non-SLA traffic flows serviced by the AP 102 is beneficial, at 1114 the AP 102 may steer the non-SLA traffic flows to the other AP and may admit the breached SLA flow. If at 1112 the AP 102 determines that steering non-SLA traffic flows serviced by the AP 102 is not beneficial, the AP 102 may return to 1104 to check the OBSS and the IBSS available airtime and the link metrics at the other nodes (the other APs 102) of the mesh network.

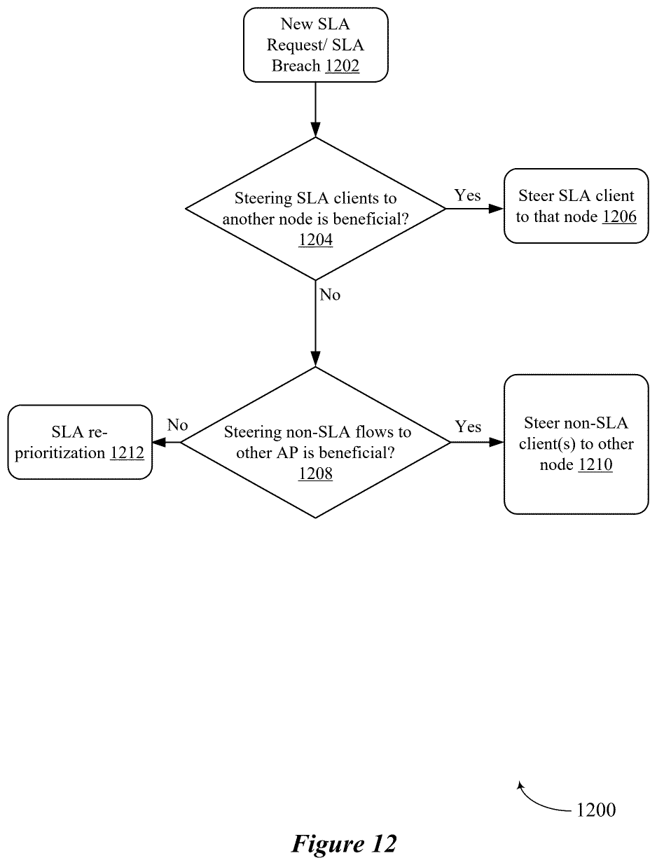

FIG. 12 shows an example of a flow diagram 1200 that supports SLA traffic flow control. The flow diagram 1200 may implement or may be implemented by aspects of the wireless communication network 100 or the signaling diagram 700. For example, the flow diagram 1200 may be implemented by an AP controller (such as the AP 102-d) of a mesh network of the signaling diagram 700 in the event of a new SLA request that exceeds the available airtime for an AP agent (such as the AP 102-b of FIG. 7) or an SLA breach at an AP agent.

At 1202, the AP controller may determine that an AP agent received a new SLA request that exceeds the available airtime for the AP agent or the AP controller may determine an SLA breach for a traffic flow at the AP agent. At 1204 The RM of the AP controller may check if steering one or more SLA traffic flows serviced by the AP agent is beneficial (for example, would allow for service of the SLA traffic flows and admittance or service of the new or breached SLA flow in accordance with the configured QoS parameters for the SLA flows). If at 1204 the AP controller determines that steering one or more SLA traffic flows serviced by the AP 102 is beneficial, at 1206 the AP controller may steer the one or more SLA traffic flows to the other AP. If at 1204 the AP controller determines that steering one or more SLA traffic flows serviced by the AP agent to another node is not beneficial, the AP controller may check at 1208 if steering non-SLA traffic flows serviced by the AP agent is beneficial (would allow for service of the SLA traffic flows and admittance or service of the new or breached SLA flow in accordance with the configured QoS parameters for the SLA flows). If at 1208 the AP 102 determines that steering non-SLA traffic flows serviced by the AP 102 is beneficial, at 1210 the AP controller may steer the non-SLA traffic flows to the other AP. If at 1210 the AP controller determines that steering non-SLA traffic flows serviced by the AP 102 is not beneficial, at 1212 the AP controller may command the AP agent to perform SLA reprioritization with one or more of the SLA traffic flows.

In some examples, in a mesh network with a wireless backhaul, the AP controller may steer a client connection from an AP agent to the AP controller to reduce the latency associated with steering, as hop latency through the AP controller for other AP agents may be avoided, and thus more airtime may be available for QoS parameters in the prioritized flow list for the mesh network. In some examples, as STA may be steered to another AP agent in the mesh network if the AP agent can provide a better SLA for latency despite a reduction in peak key performance indicators due to the reduced link metrics for the link with the other AP agent. In some examples, if the OBSS airtime at other AP agents is too high to provide any benefit on the overall latency even with a latency hop reduction (for example, at 1204), an SLA client wireless communication device may be connected to the current node and the AP controller may attempt to steer non-SLA client wireless communication devices of the AP agent to another node to reduce the IBSS airtime.

In some examples, the AP controller may check the maximum quantity of independent radios on both the AP controller and the AP agent (radios in the front haul not the back haul) as the radios may operate on independent channels. Thus, APs in the mesh network may not act as OBSS for each other on these independent channels. If the mesh network has a single backhaul, there may be a maximum of two independent radios per AP in a three radio design; and two independent radios in a four radio design. For a dual backhaul design (such as in multi link operation), the number of independent radios may be reduced. For example, for a dual backhaul, there may be a maximum of one independent radio per AP in a three radio design; and two independent radios in a four radio design.

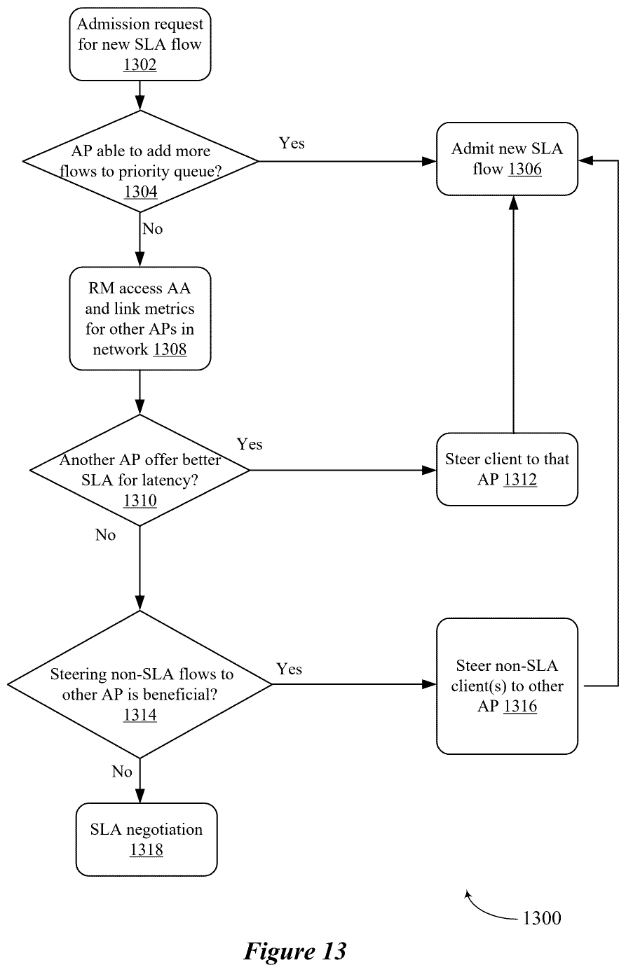

FIG. 13 shows an example of a flow diagram 1300 that supports SLA traffic flow control. The flow diagram 1300 may implement or may be implemented by aspects of the wireless communication network 100 or the signaling diagram 700. For example, the flow diagram 1300 may be implemented by an AP 102-b of the signaling diagram 700 in the event of a request for a new SLA flow from a client wireless communication device such as an STA 104. The AP 102 may be an AP 102 that supports Wi-Fi 8. The AP 102 may support multi AP coordination, where nearby APs may communicate with each other and create a BSS set where each AP has internet access. In the flow diagram 1300, in Wi-Fi 8 to accommodate a new SLA client to the priority flow list, the AP may either move a current priority SLA flow to another AP where the QoS parameters (for example, which may define latency requirements) of the client wireless communication device may be honored via client steering or move non-SLA clients to another AP where the roaming may not impact the QoS of the connected clients of the other AP to an extent to cause an SLA breach of a client at the other AP.

At 1302, the AP 102 may receive a request for admission of a new SLA flow. At 1304, the AP 102 (for example, the flow control manager 300 of the AP 102 as described with reference to FIG. 3) may determine if SLA airtime is available for the new SLA flow. For example, with reference to the available airtime diagram 350 of FIG. 3, if the new SLA flow has an airtime requirement of Q to meet the QoS demand associated with the new SLA flow, the already admitted SLA flows have an airtime demand of N, and the maximum SLA airtime is Nₘₐₓ, the new SLA flow may be admitted at 1306 if Q<Nₘₐₓ−N.

If SLA airtime is not available at 1304 for the new SLA flow (for example, if Q>Nₘₐₓ−N), at 1308 the RM of the AP may check the OBSS and the IBSS available airtime and the link metrics at the other nodes (the other APs 102) of the mesh network. At 1310, the AP 102 may determine whether another AP of the mesh network offers a better SLA for latency for the new SLA flow. If at 1310 the AP 102 determines that another AP 102 of the mesh network offers a better SLA for latency for the new SLA flow, at 1312 the AP 102 may steer the client wireless communication device to the other AP 102, and at 1306 the new SLA flow may be admitted to the network via the other AP 102. If at 1310 the AP 102 determines that no other AP 102 of the mesh network offers a better SLA for latency for the new SLA flow, at 1314 the AP 102 may check if steering non-SLA traffic flows serviced by the AP 102 is beneficial (for example, would allow for service of the non-SLA traffic flows and admittance of the new SLA flow). If at 1314 the AP 102 determines that steering non-SLA traffic flows serviced by the AP 102 is beneficial, at 1316 the AP 102 may steer the non-SLA traffic flows to the other AP and may admit the new SLA flow at 1306. If at 1314 the AP 102 determines that steering non-SLA traffic flows serviced by the AP 102 is not beneficial, at 1318 the AP 102 may perform an SLA negotiation with the client wireless communication device for the new SLA flow.

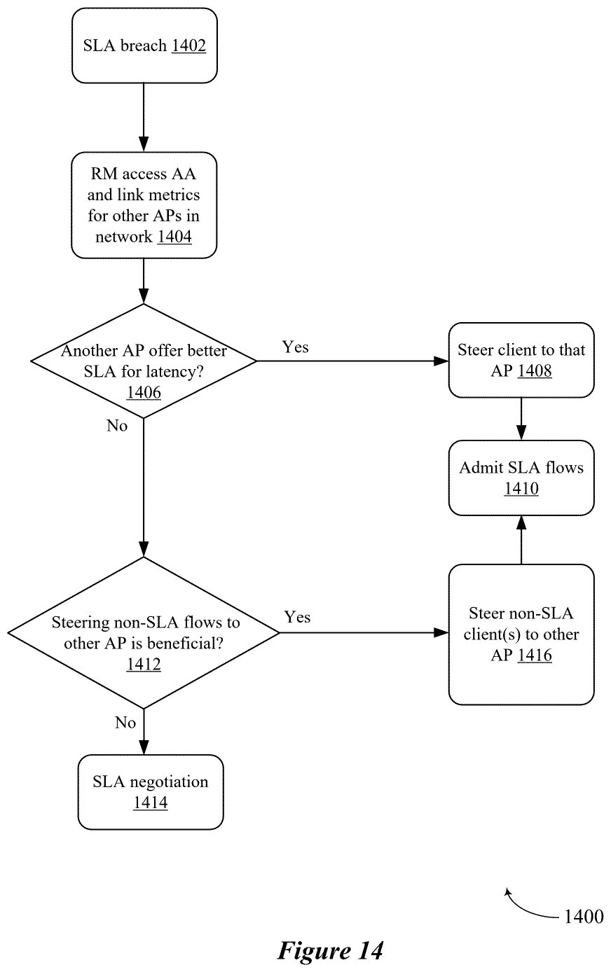

FIG. 14 shows an example of a flow diagram 1400 that supports SLA traffic flow control. The flow diagram 1400 may implement or may be implemented by aspects of the wireless communication network 100 or the signaling diagram 700. For example, the flow diagram 1400 may be implemented by an AP 102-b of the signaling diagram 700 in the event of a request for a new SLA flow from a client wireless communication device such as an STA 104. The AP 102 may be an AP 102 that supports Wi-Fi 8. The AP 102 may support multi AP coordination, where nearby APs may communicate with each other and create a BSS set where each AP has internet access. In the flow diagram 1400, in Wi-Fi 8 to accommodate a new SLA client to the priority flow list, the AP may either move a current priority SLA flow to another AP where the QoS requirements of the client wireless communication device may be honored via client steering or move non-SLA clients to another AP where the roaming may not impact the QoS of the connected clients of the other AP to an extent to cause an SLA breach of a client at the other AP.

At 1402, the AP 102 may detect an SLA breach for a traffic flow. For example, the airtime demand N of the admitted SLA flows may be greater than the threshold available airtime Nₘₐₓ for the SLA flows at the current communication resource configuration of the AP 102 (for example, of the current communication parameters).

At 1404, in response to the SLA breach at 1402, the RM of the AP 102 may check the OBSS and the IBSS available airtime and the link metrics at the other nodes (the other APs 102) of the mesh network. At 1406, the AP 102 may determine whether another AP of the mesh network offers a better SLA for latency for the breached SLA flow. If at 1406 the AP 102 determines that another AP 102 of the mesh network offers a better SLA for latency for the breached SLA flow, at 1408 the AP 102 may steer the client wireless communication device to the other AP 102, and at 1410 the breached SLA flow may be admitted to the network via the other AP 102. If at 1406 the AP 102 determines that no other AP 102 of the mesh network offers a better SLA for latency for the breached SLA flow, at 1412 the AP 102 may check if steering non-SLA traffic flows serviced by the AP 102 is beneficial (for example, would allow for service of the non-SLA traffic flows and admittance of the new SLA flow). If at 1412 the AP 102 determines that steering non-SLA traffic flows serviced by the AP 102 is beneficial, at 1416 the AP 102 may steer the non-SLA traffic flows to the other AP and may admit the breached SLA flow at 1410. If at 1412 the AP 102 determines that steering non-SLA traffic flows serviced by the AP 102 is not beneficial, at 1414 the AP 102 may perform an SLA negotiation with the client wireless communication device for the breached SLA flow.

FIG. 15 shows an example of a process flow 1500 that supports SLA traffic flow control. The process flow 1500 may implement or may be implemented by aspects of the wireless communication network 100, the signaling diagram 600, or the signaling diagram 700. For example, the process flow 1500 may include an AP 102-e, which may be an example of an AP 102 as described herein. The process flow 1500 may include an STA 104-g, which may be an example of an STA 104 as described herein. In the following description of the process flow 1500, the operations between the AP 102-e and the STA 104-g may occur in a different order than the example order shown. Additionally, or alternatively, the operations performed by the AP 102-e and the STA 104-g may be performed in different orders or at different times. Some operations also may be omitted.

The process flow 1500 may show an example of communications for an SCS negotiation for a request for a new SLA where the AP 102-d does not have sufficient available airtime to accept the initially requested SLA value.

At 1506, the STA 104-g may send an SCS request to the AP 102-e. The SCS request may indicate a SLA value X. For example, the SLA value X may indicate a QoS parameter associated with a demanded latency or priority.

At 1508, as the AP 102-e does not have sufficient available airtime to accept the initially requested SLA value X, the AP 102-e may send an SCS response that rejects the SCS request and offers a lower SLA value Y. The SCS response may invite the STA 104-g to re-initiate the request with the offered SLA value Y, where Y has a lower priority than X.

If the STA 104-g can proceed with the offered SLA value Y (for example, the traffic flow can be successfully communicated at the lower QoS parameter associated with the SLA value Y), at 1510, the STA 104-g may send a second SCS request to the AP 102-e. The second SCS request at 1510 may indicate the offered SLA value Y.

At 1512, the AP 102-e may send an SCS response that accepts the second SCS request with the SLA value Y, and the requested SLA flow may be admitted with the SLA value Y.

FIG. 16 shows an example of a process flow 1600 that supports SLA traffic flow control. The process flow 1600 may implement or may be implemented by aspects of the wireless communication network 100, the signaling diagram 600, or the signaling diagram 700. For example, the process flow 1600 may include an AP 102-f, which may be an example of an AP 102 as described herein. The process flow 1600 may include an STA 104-h, which may be an example of an STA 104 as described herein. In the following description of the process flow 1600, the operations between the AP 102-f and the STA 104-h may occur in a different order than the example order shown. Additionally, or alternatively, the operations performed by the AP 102-f and the STA 104-g may be performed in different orders or at different times. Some operations also may be omitted.

The process flow 1600 may show an example of communications for an SCS negotiation for an SLA traffic flow in the case of a breach of the SLA flow.

For example, at 1606 the STA 104-h may send an SCS request to the AP 102-f. The SCS request may indicate a SLA value X. For example, the SLA value X may indicate a QoS parameter.

At 1608, the AP 102-f may send an SCS response that accepts the SCS request with the SLA value X, and the requested SLA flow may be admitted with the SLA value X.

At 1610, the AP 102-f may detect an SLA breach for the SLA flow. For example, the AP 102-f may not have sufficient resources to support the SLA flow (for example, due to changing channel conditions).

At 1612, based on the SLA breach at 1610, the AP 102-f may send an SCS response that rejects the previously accepted SCS request and offers a lower SLA value Y in a rejection frame of the SCS response. The SCS response may invite the STA 104-h to re-initiate the request with the offered SLA value Y.

If the STA 104-h can proceed with the offered SLA value Y (for example, the traffic flow can be successfully communicated at the lower QoS parameter associated with the SLA value Y), at 1614, the STA 104-g may send a second SCS request to the AP 102-f. The second SCS request at 1614 may indicate the offered SLA value Y.

At 1616, the AP 102-f may send an SCS response that accepts the second SCS request with the SLA value Y, and the requested SLA flow may be admitted with the SLA value Y.

FIG. 17 shows an example of a process flow 1700 that supports SLA traffic flow control. The process flow 1700 may implement or may be implemented by aspects of the wireless communication network 100, the signaling diagram 600, or the signaling diagram 700. For example, the process flow 1700 may include an AP 102-g, which may be an example of an AP 102 as described herein. The process flow 1700 may include an STA 104-i, which may be an example of an STA 104 as described herein. In the following description of the process flow 1700, the operations between the AP 102-g and the STA 104-i may occur in a different order than the example order shown. Additionally, or alternatively, the operations performed by the AP 102-g and the STA 104-i may be performed in different orders or at different times. Some operations also may be omitted. The process flow 1700 may show an example of communications for an SLA re-prioritization for a non-SCS breach.

At 1706, the AP 102-g and the STA 104-i may communicate an SCS negotiated flow and one or more non-SCS flows in accordance with a negotiated QoS parameter.

At 1710, the AP 102-g may detect an SLA breach for a different, non-SCS SLA flow. For example, the AP 102-g may not have sufficient resources to support the different, non-SCS flow SLA flow (for example, due to changing channel conditions).

At 1712, based on the SLA breach at 1708, the AP 102-g may send an SCS response that rejects the previously negotiated SCS flow and a lower SLA value Y (for example, in a rejection frame of the SCS response) The SCS response may invite the STA 104-h to re-initiate the request with the offered SLA value Y. For example, the offer of the lower SLA value may be used for an SLA reprioritization when a non-SCS flow with a higher priority is breached. The AP 102-g may renegotiate a new lower SLA value for a different client that uses an SCS SLA flow to resolve the SLA breach to the non-SCS SLA flow.

If the STA 104-i can proceed with the offered SLA value Y (for example, the traffic flow can be successfully communicated at the lower QoS parameter associated with the SLA value Y), at 1714, the STA 104-i may send a second SCS request to the AP 102-g. The second SCS request at 1714 may indicate the offered SLA value Y.

At 1716, the AP 102-g may send an SCS response that accepts the second SCS request with the SLA value Y, and the requested SLA flow may be admitted with the SLA value Y.

FIG. 18 shows an example of a process flow 1800 that supports SLA traffic flow control. The process flow 1800 may implement or may be implemented by aspects of the wireless communication network 100, the signaling diagram 600, or the signaling diagram 700. For example, the process flow 1600 may include an AP 102-h, which may be an example of an AP 102 as described herein. The process flow 1800 may include an STA 104-j, which may be an example of an STA 104 as described herein. In the following description of the process flow 1800, the operations between the AP 102-h and the STA 104-j may occur in a different order than the example order shown. Additionally, or alternatively, the operations performed by the AP 102-h and the STA 104-j may be performed in different orders or at different times. Some operations also may be omitted.

The process flow 1800 may show an example of communications for an SCS negotiation for an SLA traffic flow in the case of that an insufficient QoS condition arises (for example, either due to a breach of a negotiated SLA or the request for a new SLA flow).

At 1806 the STA 104-j may send an SCS request to the AP 102-h. The SCS request may indicate a SLA value X. For example, the SLA value X may indicate a QoS parameter.

At 1808, the AP 102-h may send an SCS response that accepts the SCS request with the SLA value X, and the requested SLA flow may be admitted with the SLA value X.

At 1810, the AP 102-h may detect an insufficient QoS condition. For example, the SLA flow for the STA 104-j may be breached, or the STA 104-j or a different STA 104 may request a new SLA flow for which there is insufficient airtime available.

At 1812, based on the insufficient QoS condition, the AP 102-h may send an SCS response to the STA 104-j that may reject the previously accepted SCS SLA flow. The SCS reject frame in the SCS response at 1812 may not include an offer of a lower SLA value. For example, the SCS response may include a response code “Reject”.

At 1814, the AP 102-h may send an AP initiated request for uplink with an adjusted SLA value Y. Additionally, the AP 102-h may serve the STA 104-j in the downlink direction using a lower SLA value Y (which may be transparent to the STA 104-j).

If the STA 104-j can proceed with the offered SLA value Y, at 1816, the STA 104-i may send a second SCS request to the AP 102-g. The second SCS request at 1816 may indicate the offered SLA value Y.

At 1818, the AP 102-g may send an SCS response that accepts the second SCS request with the SLA value Y, and the requested SLA flow may be admitted with the SLA value Y.

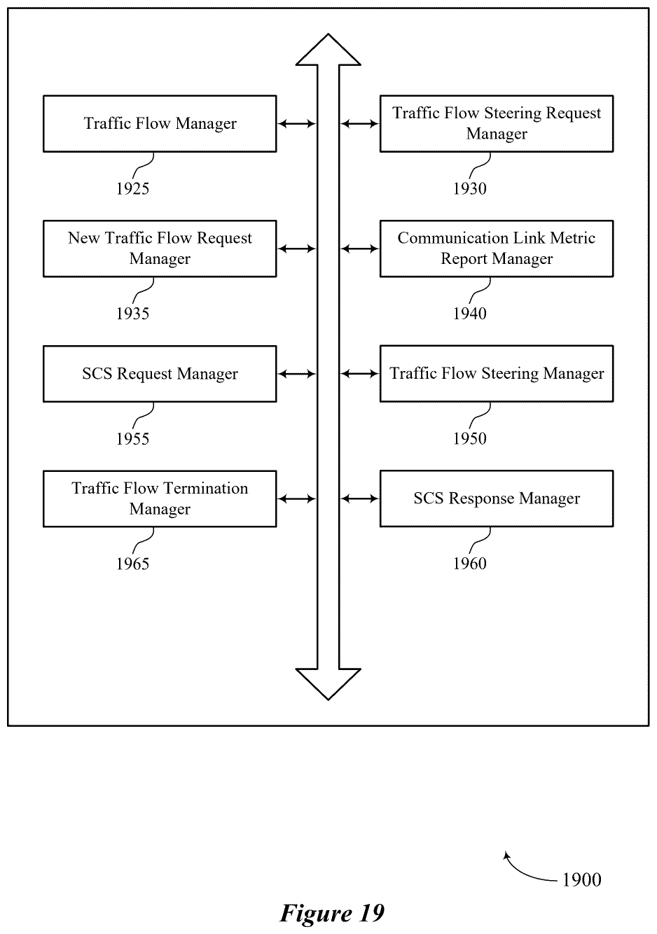

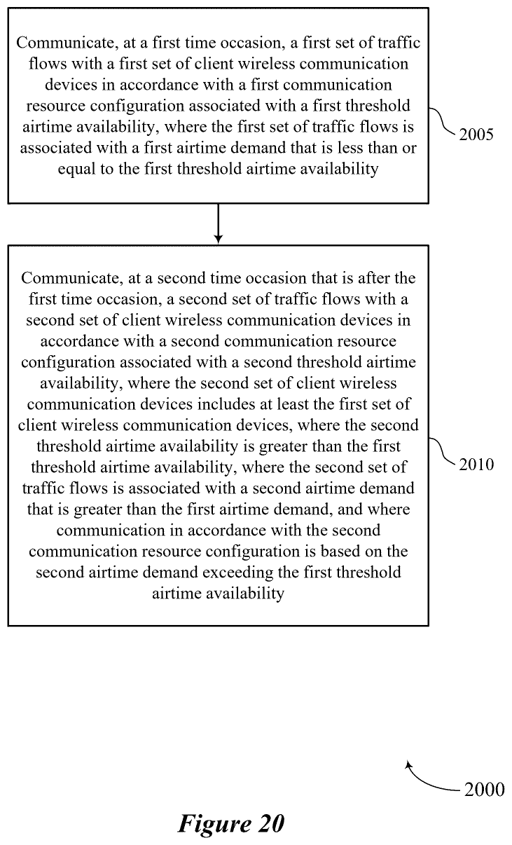

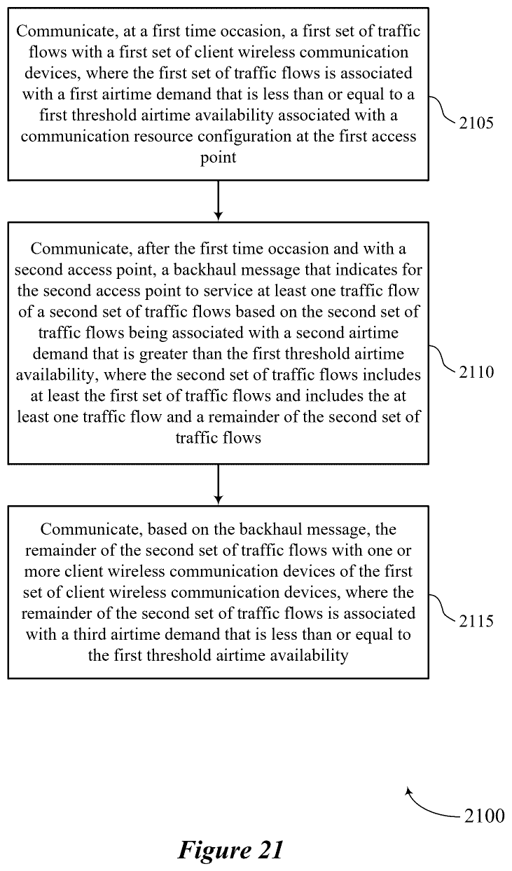

FIG. 19 shows a block diagram of an example wireless communication device 1900 that supports SLA traffic flow control. In some examples, the wireless communication device 1900 is configured to perform the processes 2000 and 2100 described with reference to FIGS. 20 and 21, respectively. The wireless communication device 1900 may include one or more chips, SoCs, chipsets, packages, components or devices that individually or collectively constitute or include a processing system. The processing system may interface with other components of the wireless communication device 1900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1900 may transmit the information output from the chip. In such an example, the second interface may refer to an interface between the processing system of the chip and a reception component, such that the wireless communication device 1900 may receive information that is then passed to the processing system. In some such examples, the first interface also may obtain information, such as from the transmission component, and the second interface also may output information, such as to the reception component.

The processing system of the wireless communication device 1900 includes processor (or “processing”) circuitry in the form of one or multiple processors, microprocessors, processing units (such as CPUs, graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1900 can be configurable or configured for use in an AP, such as the AP 102 described with reference to FIG. 1. In some other examples, the wireless communication device 1900 can be an AP that includes such a processing system and other components including multiple antennas. The wireless communication device 1900 is capable of transmitting and receiving wireless communications in the form of, for example, wireless packets. For example, the wireless communication device 1900 can be configurable or configured to transmit and receive packets in the form of physical layer PPDUs and MPDUs conforming to one or more of the IEEE 802.11 family of wireless communication protocol standards. In some other examples, the wireless communication device 1900 can be configurable or configured to transmit and receive signals and communications conforming to one or more 3GPP specifications including those for 5G NR or 6G. In some examples, the wireless communication device 1900 also includes or can be coupled with one or more application processors which may be further coupled with one or more other memories. In some examples, the wireless communication device 1900 further includes at least one external network interface coupled with the processing system that enables communication with a core network or backhaul network that enables the wireless communication device 1900 to gain access to external networks including the Internet.

The wireless communication device 1900 includes a traffic flow manager 1925, a traffic flow steering request manager 1930, a new traffic flow request manager 1935, a communication link metric report manager 1940, a traffic flow steering manager 1950, an SCS request manager 1955, an SCS response manager 1960, and a traffic flow termination manager 1965. Portions of one or more of the traffic flow manager 1925, the traffic flow steering request manager 1930, the new traffic flow request manager 1935, the communication link metric report manager 1940, the traffic flow steering manager 1950, the SCS request manager 1955, the SCS response manager 1960, and the traffic flow termination manager 1965 may be implemented at least in part in hardware or firmware. For example, one or more of the traffic flow manager 1925, the traffic flow steering request manager 1930, the new traffic flow request manager 1935, the communication link metric report manager 1940, the traffic flow steering manager 1950, the SCS request manager 1955, the SCS response manager 1960, and the traffic flow termination manager 1965 may be implemented at least in part by at least a processor or a modem. In some examples, portions of one or more of the traffic flow manager 1925, the traffic flow steering request manager 1930, the new traffic flow request manager 1935, the communication link metric report manager 1940, the traffic flow steering manager 1950, the SCS request manager 1955, the SCS response manager 1960, and the traffic flow termination manager 1965 may be implemented at least in part by a processor and software in the form of processor-executable code stored in memory.

The wireless communication device 1900 may support wireless communications in accordance with examples as disclosed herein. The traffic flow manager 1925 is configurable or configured to communicate, at a first time occasion, a first set of traffic flows with a first set of client wireless communication devices in accordance with a first communication resource configuration associated with a first threshold airtime availability, where the first set of traffic flows is associated with a first airtime demand that is less than or equal to the first threshold airtime availability. In some examples, the traffic flow manager 1925 is configurable or configured to communicate, at a second time occasion that is after the first time occasion, a second set of traffic flows with a second set of client wireless communication devices in accordance with a second communication resource configuration associated with a second threshold airtime availability, where the second set of client wireless communication devices includes at least the first set of client wireless communication devices, where the second threshold airtime availability is greater than the first threshold airtime availability, where the second set of traffic flows is associated with a second airtime demand that is greater than the first airtime demand, and where communication in accordance with the second communication resource configuration is based on the second airtime demand exceeding the first threshold airtime availability.

In some examples, the new traffic flow request manager 1935 is configurable or configured to receive, after the first time occasion, a request to add a new traffic flow, where the second set of traffic flows includes the first set of traffic flows and the new traffic flow.

In some examples, the SCS request manager 1955 is configurable or configured to receive, from a client wireless communication device of the second set of client wireless communication devices, a first stream classification service request that indicates a first quality of service characteristic associated with the new traffic flow. In some examples, the SCS response manager 1960 is configurable or configured to transmit, to the client wireless communication device based on a breach of the first quality of service characteristic using the second communication resource configuration, a first stream classification service response indicating a second quality of service characteristic associated with the new traffic flow, the second quality of service characteristic reduced with respect to the first quality of service characteristic. In some examples, the SCS request manager 1955 is configurable or configured to receive, from the client wireless communication device and based on the first stream classification service response, a second stream classification service request that indicates the second quality of service characteristic associated with the new traffic flow. In some examples, the SCS response manager 1960 is configurable or configured to transmit, to the client wireless communication device and based on the second stream classification service request, a second stream classification service response that indicates an acceptance of the second quality of service characteristic.

In some examples, the SCS request manager 1955 is configurable or configured to receive, from a client wireless communication device of the second set of client wireless communication devices, a first stream classification service request that indicates a first quality of service characteristic associated with the new traffic flow. In some examples, the SCS response manager 1960 is configurable or configured to transmit, to the client wireless communication device based on the first stream classification service request, a first stream classification service response indicating an acceptance of the first quality of service characteristic, where communicating the second set of traffic flows at the second time occasion is based on the first stream classification service response. In some examples, the traffic flow termination manager 1965 is configurable or configured to transmit, to the client wireless communication device based on a breach of the first quality of service characteristic using the second communication resource configuration, a second stream classification service response that terminates the new traffic flow. In some examples, the SCS request manager 1955 is configurable or configured to receive, from the client wireless communication device and based on the second stream classification service response, a second stream classification service request that indicates a second quality of service characteristic associated with the new traffic flow, the second quality of service characteristic reduced with respect to the first quality of service characteristic. In some examples, the SCS response manager 1960 is configurable or configured to transmit, to the client wireless communication device and based on the second stream classification service request, a third stream classification service response that indicates an acceptance of the second quality of service characteristic.

In some examples, the second set of traffic flows is a same as the first set of traffic flows.

In some examples, the SCS request manager 1955 is configurable or configured to receive, from a client wireless communication device of the first set of client wireless communication devices, a first stream classification service request that indicates a first quality of service characteristic associated with a first traffic flow of the first set of traffic flows. In some examples, the SCS response manager 1960 is configurable or configured to transmit, to the client wireless communication device based on the first stream classification service request, a first stream classification service response indicating an acceptance of the first quality of service characteristic, where communicating the first set of traffic flows at the first time occasion is based on the first stream classification service response. In some examples, the SCS response manager 1960 is configurable or configured to transmit, to the client wireless communication device based on a breach of the first quality of service characteristic using the second communication resource configuration, a second stream classification service response indicating a second quality of service characteristic associated with the first traffic flow, the second quality of service characteristic reduced with respect to the first quality of service characteristic. In some examples, the SCS request manager 1955 is configurable or configured to receive, from the client wireless communication device and based on the second stream classification service response, a second stream classification service request that indicates the second quality of service characteristic associated with the first traffic flow. In some examples, the SCS response manager 1960 is configurable or configured to transmit, to the client wireless communication device and based on the second stream classification service request, a third stream classification service response that indicates an acceptance of the second quality of service characteristic.

In some examples, the SCS request manager 1955 is configurable or configured to receive, from a client wireless communication device of the first set of client wireless communication devices, a first stream classification service request that indicates a first quality of service characteristic associated with a first traffic flow of the first set of traffic flows. In some examples, the SCS response manager 1960 is configurable or configured to transmit, to the client wireless communication device based on the first stream classification service request, a first stream classification service response indicating an acceptance of the first quality of service characteristic, where communicating the first set of traffic flows at the first time occasion is based on the first stream classification service response. In some examples, the traffic flow termination manager 1965 is configurable or configured to transmit, to the client wireless communication device based on a breach of the first quality of service characteristic using the second communication resource configuration, a second stream classification service response that terminates the first traffic flow, where the second stream classification service response indicates one or more candidate second quality of service characteristics associated with the first traffic flow, the one or more candidate second quality of service characteristics reduced with respect to the first quality of service characteristic. In some examples, the SCS request manager 1955 is configurable or configured to receive, from the client wireless communication device and based on the second stream classification service response, a second stream classification service request that indicates a second quality of service characteristic from the one or more candidate second quality of service characteristics. In some examples, the SCS response manager 1960 is configurable or configured to transmit, to the client wireless communication device and based on the second stream classification service request, a third stream classification service response that indicates an acceptance of the second quality of service characteristic.

In some examples, the traffic flow termination manager 1965 is configurable or configured to transmit, to a client wireless communication device of the first set of client wireless communication devices and based on a breach of a first quality of service characteristic associated with a traffic flow of the second set of traffic flows using the second communication resource configuration, a first stream classification message that terminates the traffic flow. In some examples, the SCS request manager 1955 is configurable or configured to receive, from the client wireless communication device and based on the first stream classification message, a stream classification service request that indicates a second quality of service characteristic associated with the traffic flow, the second quality of service characteristic reduced with respect to the first quality of service characteristic. In some examples, the SCS response manager 1960 is configurable or configured to transmit, to the client wireless communication device and based on the stream classification service request, a stream classification service response that indicates an acceptance of the second quality of service characteristic.

In some examples, the first communication resource configuration includes: a first transmission power level, a first quantity of spatial streams, a first quantity of memory, a first quantity of central processing unit resources, a first bandwidth, or a first combination thereof. In some examples, the second communication resource configuration includes: a second transmission power level greater than the first transmission power level, a second quantity of spatial streams greater than the first quantity of spatial streams, a second quantity of memory greater than the first quantity of memory, a second quantity of central processing unit resources greater than the first quantity of central processing unit resources, a second bandwidth greater than the first bandwidth, or a second combination thereof.

In some examples, the first communication resource configuration is associated with a first energy consumption mode at the AP. In some examples, the second communication resource configuration is associated with a second energy consumption mode at the AP. In some examples, the second energy consumption mode is associated with higher power than the first energy consumption mode.

In some examples, to support communicating the second set of traffic flows, the traffic flow manager 1925 is configurable or configured to communicate the second set of traffic flows via a second communication channel associated with a second interference level, where the first set of traffic flows are communicated via a first communication channel associated with a first interference level, and where communication of the second set of traffic flows is via the second communication channel based on the second interference level being less than the first interference level.

In some examples, the second communication resource configuration includes a set of multiple parameters adjusted with respect to the first communication resource configuration. In some examples, subsets of the set of multiple parameters are adjusted sequentially in time between the first time occasion and the second time occasion with respective back-off time durations between adjustments of respective subsets.

Additionally, or alternatively, the wireless communication device 1900 may support wireless communications in accordance with examples as disclosed herein. In some examples, the traffic flow manager 1925 is configurable or configured to communicate, at a first time occasion, a first set of traffic flows with a first set of client wireless communication devices, where the first set of traffic flows is associated with a first airtime demand that is less than or equal to a first threshold airtime availability associated with a communication resource configuration at the first AP. The traffic flow steering request manager 1930 is configurable or configured to communicate, after the first time occasion and with a second AP, a backhaul message that indicates for the second AP to service at least one traffic flow of a second set of traffic flows based on the second set of traffic flows being associated with a second airtime demand that is greater than the first threshold airtime availability, where the second set of traffic flows includes at least the first set of traffic flows and includes the at least one traffic flow and a remainder of the second set of traffic flows. In some examples, the traffic flow manager 1925 is configurable or configured to communicate, based on the backhaul message, the remainder of the second set of traffic flows with one or more client wireless communication devices of the first set of client wireless communication devices, where the remainder of the second set of traffic flows is associated with a third airtime demand that is less than or equal to the first threshold airtime availability.

In some examples, the communication link metric report manager 1940 is configurable or configured to receive, from a set of neighbor APs, one or more reports that indicate communication link metrics associated with respective communication links between the set of neighbor APs and the first set of client wireless communication devices, where the set of neighbor APs includes the second AP, and where communicating the backhaul message is based on a respective link metric associated with a respective communication link between the second AP and a client wireless communication of the first set of client wireless communication devices that is associated with the at least one traffic flow satisfying a communication link metric threshold.

In some examples, the SCS request manager 1955 is configurable or configured to receive a stream classification service request message for a traffic flow from a client wireless communication device that indicate a first traffic identifier associated with the traffic flow. In some examples, the SCS response manager 1960 is configurable or configured to communicate, based on the second set of traffic flows being associated with the second airtime demand that is greater than the first threshold airtime availability and based on respective link metrics associated with respective communication links between the set of neighbor APs and the client wireless communication device failing to satisfy the communication link metric threshold, the traffic flow in accordance with a second traffic identifier that is associated with a lower priority than the first traffic identifier.

In some examples, the communication link metric threshold is a latency threshold.

In some examples, the backhaul message indicates for the second AP to service one or more traffic flows associated with a first client wireless communication device of the first set of client wireless communication devices. In some examples, the one or more traffic flows include the at least one traffic flow. In some examples, the one or more client wireless communication devices include a remainder of the first set of client wireless communication devices other than the first client wireless communication device.

In some examples, the backhaul message indicates for the second AP to service a subset of traffic flows associated with a first client wireless communication device and a second client wireless communication device of the first set of client wireless communication devices. In some examples, the subset of traffic flows includes the at least one traffic flow. In some examples, the one or more client wireless communication devices include a remainder of the first set of client wireless communication devices other than the first client wireless communication device and the second client wireless communication device.

In some examples, the backhaul message indicates for the second access point to service the subset of traffic flows based on: the first client wireless communication device and the second client wireless communication device being non-SLA clients of the first AP; and the first AP determining not to steer at least one or more client wireless communication devices of the remainder of the first set of client wireless communication devices that are SLA clients of the first AP to the second AP.

In some examples, the traffic flow steering request manager 1930 is configurable or configured to communicate, after the first time occasion and with a third AP, a second backhaul message that indicates for the third AP to service at least second one traffic flow of the second set of traffic flows based on the second set of traffic flows being associated with the second airtime demand that is greater than the first threshold airtime availability.

In some examples, the new traffic flow request manager 1935 is configurable or configured to receive, after the first time occasion, a request to add a new traffic flow, where the second set of traffic flows includes the first set of traffic flows and the new traffic flow.

In some examples, the at least one traffic flow includes the new traffic flow.

In some examples, the second set of traffic flows is a same as the first set of traffic flows.

In some examples, the first AP is associated with a first BSS. In some examples, the second AP is associated with a second BSS. In some examples, the backhaul message is multi-AP coordination message.

In some examples, the traffic flow steering manager 1950 is configurable or configured to receive a control message from a controller of a mesh network that includes the first AP and the second AP, where the control message indicates to steer the at least one traffic flow to the second AP, where transmission of the backhaul message is based on the control message.

In some examples, the traffic flow steering manager 1950 is configurable or configured to determine, at the first AP and based on the second set of traffic flows being associated with the second airtime demand that is greater than the first threshold airtime availability, to steer the at least one traffic flow to the second AP, where transmission of the backhaul message is based on the determination.

FIG. 20 shows a flowchart illustrating an example process 2000 performable by or at an AP that supports SLA traffic flow control. The operations of the process 2000 may be implemented by an AP or its components as described herein. For example, the process 2000 may be performed by a wireless communication device, such as the wireless communication device 1900 described with reference to FIG. 19, operating as or within a wireless AP. In some examples, the process 2000 may be performed by a wireless AP, such as one of the APs 102 described with reference to FIG. 1.

In some examples, in 2005, the AP may communicate, at a first time occasion, a first set of traffic flows with a first set of client wireless communication devices in accordance with a first communication resource configuration associated with a first threshold airtime availability, where the first set of traffic flows is associated with a first airtime demand that is less than or equal to the first threshold airtime availability. The operations of 2005 may be performed in accordance with examples as disclosed herein, such as in accordance with the communication of the traffic flows 610 of FIG. 6. In some implementations, aspects of the operations of 2005 may be performed by a traffic flow manager 1925 as described with reference to FIG. 19.

In some examples, in 2010, the AP may communicate, at a second time occasion that is after the first time occasion, a second set of traffic flows with a second set of client wireless communication devices in accordance with a second communication resource configuration associated with a second threshold airtime availability, where the second set of client wireless communication devices includes at least the first set of client wireless communication devices, where the second threshold airtime availability is greater than the first threshold airtime availability, where the second set of traffic flows is associated with a second airtime demand that is greater than the first airtime demand, and where communication in accordance with the second communication resource configuration is based on the second airtime demand exceeding the first threshold airtime availability. The operations of 2010 may be performed in accordance with examples as disclosed herein, such as in accordance with the communication of the traffic flows 610 of FIG. 6. In some implementations, aspects of the operations of 2010 may be performed by a traffic flow manager 1925 as described with reference to FIG. 19.

FIG. 21 shows a flowchart illustrating an example process 2100 performable by or at a first AP that supports SLA traffic flow control. The operations of the process 2100 may be implemented by a first AP or its components as described herein. For example, the process 2100 may be performed by a wireless communication device, such as the wireless communication device 1900 described with reference to FIG. 19, operating as or within a wireless AP. In some examples, the process 2100 may be performed by a wireless AP, such as one of the APs 102 described with reference to FIG. 1.

In some examples, in 2105, the first AP may communicate, at a first time occasion, a first set of traffic flows with a first set of client wireless communication devices, where the first set of traffic flows is associated with a first airtime demand that is less than or equal to a first threshold airtime availability associated with a communication resource configuration at the first AP. The operations of 2105 may be performed in accordance with examples as disclosed herein, such as in accordance with the communication of the traffic flows 710 of FIG. 7. In some implementations, aspects of the operations of 2105 may be performed by a traffic flow manager 1925 as described with reference to FIG. 19.

In some examples, in 2110, the first AP may communicate, after the first time occasion and with a second AP, a backhaul message that indicates for the second AP to service at least one traffic flow of a second set of traffic flows based on the second set of traffic flows being associated with a second airtime demand that is greater than the first threshold airtime availability, where the second set of traffic flows includes at least the first set of traffic flows and includes the at least one traffic flow and a remainder of the second set of traffic flows. The operations of 2110 may be performed in accordance with examples as disclosed herein, such as in accordance with the communication of the backhaul message 716 of FIG. 7. In some implementations, aspects of the operations of 2110 may be performed by a traffic flow steering request manager 1930 as described with reference to FIG. 19.

In some examples, in 2115, the first AP may communicate, based on the backhaul message, the remainder of the second set of traffic flows with one or more client wireless communication devices of the first set of client wireless communication devices, where the remainder of the second set of traffic flows is associated with a third airtime demand that is less than or equal to the first threshold airtime availability. The operations of 2115 may be performed in accordance with examples as disclosed herein, such as in accordance with the communication of the traffic flows 710 of FIG. 7. In some implementations, aspects of the operations of 2115 may be performed by a traffic flow manager 1925 as described with reference to FIG. 19.

Implementation examples are described in the following numbered clauses:

Aspect 1: A method for wireless communications at an AP, including: communicating, at a first time occasion, a first set of traffic flows with a first set of client wireless communication devices in accordance with a first communication resource configuration associated with a first threshold airtime availability, where the first set of traffic flows is associated with a first airtime demand that is less than or equal to the first threshold airtime availability; and communicating, at a second time occasion that is after the first time occasion, a second set of traffic flows with a second set of client wireless communication devices in accordance with a second communication resource configuration associated with a second threshold airtime availability, where the second set of client wireless communication devices includes at least the first set of client wireless communication devices, where the second threshold airtime availability is greater than the first threshold airtime availability, where the second set of traffic flows is associated with a second airtime demand that is greater than the first airtime demand, and where communication in accordance with the second communication resource configuration is based at least in part on the second airtime demand exceeding the first threshold airtime availability.

Aspect 2: The method of aspect 1, further including: receiving, after the first time occasion, a request to add a new traffic flow, where the second set of traffic flows includes the first set of traffic flows and the new traffic flow.

Aspect 3: The method of aspect 2, further including: receiving, from a client wireless communication device of the second set of client wireless communication devices, a first stream classification service request that indicates a first QoS characteristic associated with the new traffic flow; transmitting, to the client wireless communication device based at least in part on a breach of the first QoS characteristic using the second communication resource configuration, a first stream classification service response indicating a second QoS characteristic associated with the new traffic flow, the second QoS characteristic reduced with respect to the first QoS characteristic; receiving, from the client wireless communication device and based at least in part on the first stream classification service response, a second stream classification service request that indicates the second QoS characteristic associated with the new traffic flow; and transmitting, to the client wireless communication device and based at least in part on the second stream classification service request, a second stream classification service response that indicates an acceptance of the second QoS characteristic.

Aspect 4: The method of aspect 2, further including: receiving, from a client wireless communication device of the second set of client wireless communication devices, a first stream classification service request that indicates a first QoS characteristic associated with the new traffic flow; transmitting, to the client wireless communication device based at least in part on the first stream classification service request, a first stream classification service response indicating an acceptance of the first QoS characteristic, where communicating the second set of traffic flows at the second time occasion is based at least in part on the first stream classification service response; transmitting, to the client wireless communication device based at least in part on a breach of the first QoS characteristic using the second communication resource configuration, a second stream classification service response that terminates the new traffic flow; receiving, from the client wireless communication device and based at least in part on the second stream classification service response, a second stream classification service request that indicates a second QoS characteristic associated with the new traffic flow, the second QoS characteristic reduced with respect to the first QoS characteristic; and transmitting, to the client wireless communication device and based at least in part on the second stream classification service request, a third stream classification service response that indicates an acceptance of the second QoS characteristic.

Aspect 5: The method of aspect 1, where the second set of traffic flows is a same as the first set of traffic flows.

Aspect 6: The method of aspect 5, further including: receiving, from a client wireless communication device of the first set of client wireless communication devices, a first stream classification service request that indicates a first QoS characteristic associated with a first traffic flow of the first set of traffic flows; transmitting, to the client wireless communication device based at least in part on the first stream classification service request, a first stream classification service response indicating an acceptance of the first QoS characteristic, where communicating the first set of traffic flows at the first time occasion is based at least in part on the first stream classification service response; transmitting, to the client wireless communication device based at least in part on a breach of the first QoS characteristic using the second communication resource configuration, a second stream classification service response indicating a second QoS characteristic associated with the first traffic flow, the second QoS characteristic reduced with respect to the first QoS characteristic; receiving, from the client wireless communication device and based at least in part on the second stream classification service response, a second stream classification service request that indicates the second QoS characteristic associated with the first traffic flow; and transmitting, to the client wireless communication device and based at least in part on the second stream classification service request, a third stream classification service response that indicates an acceptance of the second QoS characteristic.

Aspect 7: The method of aspect 5, further including: receiving, from a client wireless communication device of the first set of client wireless communication devices, a first stream classification service request that indicates a first QoS characteristic associated with a first traffic flow of the first set of traffic flows; transmitting, to the client wireless communication device based at least in part on the first stream classification service request, a first stream classification service response indicating an acceptance of the first QoS characteristic, where communicating the first set of traffic flows at the first time occasion is based at least in part on the first stream classification service response; transmitting, to the client wireless communication device based at least in part on a breach of the first QoS characteristic using the second communication resource configuration, a second stream classification service response that terminates the first traffic flow, where the second stream classification service response indicates one or more candidate second QoS characteristics associated with the first traffic flow, the one or more candidate second QoS characteristics reduced with respect to the first QoS characteristic; receiving, from the client wireless communication device and based at least in part on the second stream classification service response, a second stream classification service request that indicates a second QoS characteristic from the one or more candidate second QoS characteristics; and transmitting, to the client wireless communication device and based at least in part on the second stream classification service request, a third stream classification service response that indicates an acceptance of the second QoS characteristic.

Aspect 8: The method of aspect 5, further including: transmitting, to a client wireless communication device of the first set of client wireless communication devices and based at least in part on a breach of a first QoS characteristic associated with a traffic flow of the second set of traffic flows using the second communication resource configuration, a first stream classification message that terminates the traffic flow; receiving, from the client wireless communication device and based at least in part on the first stream classification message, a stream classification service request that indicates a second QoS characteristic associated with the traffic flow, the second QoS characteristic reduced with respect to the first QoS characteristic; and transmitting, to the client wireless communication device and based at least in part on the stream classification service request, a stream classification service response that indicates an acceptance of the second QoS characteristic.

Aspect 9: The method of aspect 5, where the first communication resource configuration includes: a first transmission power level, a first quantity of spatial streams, a first quantity of memory, a first quantity of central processing unit resources, a first bandwidth, or a first combination thereof; and where the second communication resource configuration includes a second transmission power level greater than the first transmission power level, a second quantity of spatial streams greater than the first quantity of spatial streams, a second quantity of memory greater than the first quantity of memory, a second quantity of central processing unit resources greater than the first quantity of central processing unit resources, a second bandwidth greater than the first bandwidth, or a second combination thereof.

Aspect 10: The method of any of aspects 1-9, where the first communication resource configuration is associated with a first energy consumption mode at the AP, the second communication resource configuration is associated with a second energy consumption mode at the AP, and the second energy consumption mode is associated with higher power than the first energy consumption mode.

Aspect 11: The method of any of aspects 1-10, where communicating the second set of traffic flows includes: communicating the second set of traffic flows via a second communication channel associated with a second interference level, where the first set of traffic flows are communicated via a first communication channel associated with a first interference level, and where communication of the second set of traffic flows is via the second communication channel based at least in part on the second interference level being less than the first interference level.

Aspect 12: The method of any of aspects 1-11, where the second communication resource configuration includes a plurality of parameters adjusted with respect to the first communication resource configuration, and subsets of the plurality of parameters are adjusted sequentially in time between the first time occasion and the second time occasion with respective back-off time durations between adjustments of respective subsets.

Aspect 13: A method for wireless communications at a first AP, including: communicating, at a first time occasion, a first set of traffic flows with a first set of client wireless communication devices, where the first set of traffic flows is associated with a first airtime demand that is less than or equal to a first threshold airtime availability associated with a communication resource configuration at the first AP; communicating, after the first time occasion and with a second AP, a backhaul message that indicates for the second AP to service at least one traffic flow of a second set of traffic flows based at least in part on the second set of traffic flows being associated with a second airtime demand that is greater than the first threshold airtime availability, where the second set of traffic flows includes at least the first set of traffic flows and includes the at least one traffic flow and a remainder of the second set of traffic flows; and communicating, based at least in part on the backhaul message, the remainder of the second set of traffic flows with one or more client wireless communication devices of the first set of client wireless communication devices, where the remainder of the second set of traffic flows is associated with a third airtime demand that is less than or equal to the first threshold airtime availability.

Aspect 14: The method of aspect 13, further including: receiving, from a set of neighbor APs, one or more reports that indicate communication link metrics associated with respective communication links between the set of neighbor APs and the first set of client wireless communication devices, where the set of neighbor APs includes the second AP, and where communicating the backhaul message is based at least in part on a respective link metric associated with a respective communication link between the second AP and a client wireless communication of the first set of client wireless communication devices that is associated with the at least one traffic flow satisfying a communication link metric threshold.

Aspect 15: The method of aspect 14, further including: receiving a stream classification service request message for a traffic flow from a client wireless communication device that indicate a first traffic identifier associated with the traffic flow; and communicating, based at least in part on the second set of traffic flows being associated with the second airtime demand that is greater than the first threshold airtime availability and based at least in part on respective link metrics associated with respective communication links between the set of neighbor APs and the client wireless communication device failing to satisfy the communication link metric threshold, the traffic flow in accordance with a second traffic identifier that is associated with a lower priority than the first traffic identifier.

Aspect 16: The method of any of aspects 14-15, where the communication link metric threshold is a latency threshold.

Aspect 17: The method of any of aspects 13-16, where the backhaul message indicates for the second AP to service one or more traffic flows associated with a first client wireless communication device of the first set of client wireless communication devices, the one or more traffic flows comprise the at least one traffic flow, and the one or more client wireless communication devices comprise a remainder of the first set of client wireless communication devices other than the first client wireless communication device.

Aspect 18: The method of any of aspects 13-16, where the backhaul message indicates for the second AP to service a subset of traffic flows associated with a first client wireless communication device and a second client wireless communication device of the first set of client wireless communication devices, the subset of traffic flows includes the at least one traffic flow, and the one or more client wireless communication devices comprise a remainder of the first set of client wireless communication devices other than the first client wireless communication device and the second client wireless communication device.

Aspect 19: The method of aspect 18, where the backhaul message indicates for the second AP to service the subset of traffic flows based at least in part on: the first client wireless communication device and the second client wireless communication device being non-SLA clients of the first AP; and the first AP determining not to steer at least one or more client wireless communication devices of the remainder of the first set of client wireless communication devices that are SLA clients of the first AP to the second AP.

Aspect 20: The method of any of aspects 13-19, further including: communicating, after the first time occasion and with a third AP, a second backhaul message that indicates for the third AP to service at least second one traffic flow of the second set of traffic flows based at least in part on the second set of traffic flows being associated with the second airtime demand that is greater than the first threshold airtime availability.

Aspect 21: The method of any of aspects 13-20, further including: receiving, after the first time occasion, a request to add a new traffic flow, where the second set of traffic flows includes the first set of traffic flows and the new traffic flow.

Aspect 22: The method of aspect 21, where the at least one traffic flow includes the new traffic flow.

Aspect 23: The method of any of aspects 13-20, where the second set of traffic flows is a same as the first set of traffic flows.

Aspect 24: The method of any of aspects 13-23, where the first AP is associated with a first BSS, the second AP is associated with a second BSS, and the backhaul message is multi-AP coordination message.

Aspect 25: The method of any of aspects 13-24, further including: receiving a control message from a controller of a mesh network that includes the first AP and the second AP, where the control message indicates to steer the at least one traffic flow to the second AP, where transmission of the backhaul message is based at least in part on the control message.

Aspect 26: The method of any of aspects 13-25, further including: determining, at the first AP and based at least in part on the second set of traffic flows being associated with the second airtime demand that is greater than the first threshold airtime availability, to steer the at least one traffic flow to the second AP, where transmission of the backhaul message is based at least in part on the determination.

Aspect 27: An AP for wireless communications, including a processing system that includes processor circuitry and memory circuitry that stores code, the processing system configured to cause the AP to perform a method of any of aspects 1-12.

Aspect 28: An AP for wireless communications, including at least one means for performing a method of any of aspects 1-12.

Aspect 29: A non-transitory computer-readable medium storing code for wireless communications, the code including instructions executable by one or more processors to perform a method of any of aspects 1-12.

Aspect 30: A first AP including a processing system that includes processor circuitry and memory circuitry that stores code, the processing system configured to cause the first AP to perform a method of any of aspects 13-26.

Aspect 31: A first AP for wireless communications, including at least one means for performing a method of any of aspects 13-26.

Aspect 32: A non-transitory computer-readable medium storing code for wireless communications, the code including instructions executable by one or more processors to perform a method of any of aspects 13-26.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An access point, comprising:
a processing system that includes processor circuitry and memory circuitry that stores code, the processing system configured to cause the access point to:
communicate, at a first time occasion, a first set of traffic flows with a first set of client wireless communication devices in accordance with a first communication resource configuration associated with a first threshold airtime availability, wherein the first set of traffic flows is associated with a first airtime demand that is less than or equal to the first threshold airtime availability; and
communicate, at a second time occasion that is after the first time occasion, a second set of traffic flows with a second set of client wireless communication devices in accordance with a second communication resource configuration associated with a second threshold airtime availability, wherein the second set of client wireless communication devices comprises at least the first set of client wireless communication devices, wherein the second threshold airtime availability is greater than the first threshold airtime availability, wherein the second set of traffic flows is associated with a second airtime demand that is greater than the first airtime demand, and wherein communication in accordance with the second communication resource configuration is based at least in part on the second airtime demand exceeding the first threshold airtime availability.

2. The access point of claim 1, wherein the processing system is further configured to cause the access point to:
receive, after the first time occasion, a request to add a new traffic flow, wherein the second set of traffic flows comprises the first set of traffic flows and the new traffic flow.

3. The access point of claim 2, wherein the processing system is further configured to cause the access point to:
receive, from a client wireless communication device of the second set of client wireless communication devices, a first stream classification service request that indicates a first quality of service characteristic associated with the new traffic flow;
transmit, to the client wireless communication device based at least in part on a breach of the first quality of service characteristic using the second communication resource configuration, a first stream classification service response indicating a second quality of service characteristic associated with the new traffic flow, the second quality of service characteristic reduced with respect to the first quality of service characteristic;
receive, from the client wireless communication device and based at least in part on the first stream classification service response, a second stream classification service request that indicates the second quality of service characteristic associated with the new traffic flow; and
transmit, to the client wireless communication device and based at least in part on the second stream classification service request, a second stream classification service response that indicates an acceptance of the second quality of service characteristic.

4. The access point of claim 2, wherein the processing system is further configured to cause the access point to:
receive, from a client wireless communication device of the second set of client wireless communication devices, a first stream classification service request that indicates a first quality of service characteristic associated with the new traffic flow;
transmit, to the client wireless communication device based at least in part on the first stream classification service request, a first stream classification service response indicating an acceptance of the first quality of service characteristic, wherein communicating the second set of traffic flows at the second time occasion is based at least in part on the first stream classification service response;
transmit, to the client wireless communication device based at least in part on a breach of the first quality of service characteristic using the second communication resource configuration, a second stream classification service response that terminates the new traffic flow;
receive, from the client wireless communication device and based at least in part on the second stream classification service response, a second stream classification service request that indicates a second quality of service characteristic associated with the new traffic flow, the second quality of service characteristic reduced with respect to the first quality of service characteristic; and
transmit, to the client wireless communication device and based at least in part on the second stream classification service request, a third stream classification service response that indicates an acceptance of the second quality of service characteristic.

5. The access point of claim 1, wherein the second set of traffic flows is a same as the first set of traffic flows.

6. The access point of claim 5, wherein the processing system is further configured to cause the access point to:
receive, from a client wireless communication device of the first set of client wireless communication devices, a first stream classification service request that indicates a first quality of service characteristic associated with a first traffic flow of the first set of traffic flows;
transmit, to the client wireless communication device based at least in part on the first stream classification service request, a first stream classification service response indicating an acceptance of the first quality of service characteristic, wherein communicating the first set of traffic flows at the first time occasion is based at least in part on the first stream classification service response;
transmit, to the client wireless communication device based at least in part on a breach of the first quality of service characteristic using the second communication resource configuration, a second stream classification service response indicating a second quality of service characteristic associated with the first traffic flow, the second quality of service characteristic reduced with respect to the first quality of service characteristic;
receive, from the client wireless communication device and based at least in part on the second stream classification service response, a second stream classification service request that indicates the second quality of service characteristic associated with the first traffic flow; and
transmit, to the client wireless communication device and based at least in part on the second stream classification service request, a third stream classification service response that indicates an acceptance of the second quality of service characteristic.

7. The access point of claim 5, wherein the processing system is further configured to cause the access point to:
receive, from a client wireless communication device of the first set of client wireless communication devices, a first stream classification service request that indicates a first quality of service characteristic associated with a first traffic flow of the first set of traffic flows;
transmit, to the client wireless communication device based at least in part on the first stream classification service request, a first stream classification service response indicating an acceptance of the first quality of service characteristic, wherein communicating the first set of traffic flows at the first time occasion is based at least in part on the first stream classification service response;
transmit, to the client wireless communication device based at least in part on a breach of the first quality of service characteristic using the second communication resource configuration, a second stream classification service response that terminates the first traffic flow, wherein the second stream classification service response indicates one or more candidate second quality of service characteristics associated with the first traffic flow, the one or more candidate second quality of service characteristics reduced with respect to the first quality of service characteristic;
receive, from the client wireless communication device and based at least in part on the second stream classification service response, a second stream classification service request that indicates a second quality of service characteristic from the one or more candidate second quality of service characteristics; and
transmit, to the client wireless communication device and based at least in part on the second stream classification service request, a third stream classification service response that indicates an acceptance of the second quality of service characteristic.

8. The access point of claim 5, wherein the processing system is further configured to cause the access point to:
transmit, to a client wireless communication device of the first set of client wireless communication devices and based at least in part on a breach of a first quality of service characteristic associated with a traffic flow of the second set of traffic flows using the second communication resource configuration, a first stream classification message that terminates the traffic flow;
receive, from the client wireless communication device and based at least in part on the first stream classification message, a stream classification service request that indicates a second quality of service characteristic associated with the traffic flow, the second quality of service characteristic reduced with respect to the first quality of service characteristic; and
transmit, to the client wireless communication device and based at least in part on the stream classification service request, a stream classification service response that indicates an acceptance of the second quality of service characteristic.

9. The access point of claim 1, wherein:
the first communication resource configuration comprises a first transmission power level, a first quantity of spatial streams, a first quantity of memory, a first quantity of central processing unit resources, a first bandwidth, or a first combination thereof; and
the second communication resource configuration comprises a second transmission power level greater than the first transmission power level, a second quantity of spatial streams greater than the first quantity of spatial streams, a second quantity of memory greater than the first quantity of memory, a second quantity of central processing unit resources greater than the first quantity of central processing unit resources, a second bandwidth greater than the first bandwidth, or a second combination thereof.

10. The access point of claim 1, wherein:
the first communication resource configuration is associated with a first energy consumption mode at the access point,
the second communication resource configuration is associated with a second energy consumption mode at the access point, and
the second energy consumption mode is associated with higher power than the first energy consumption mode.

11. The access point of claim 1, wherein, to communicate the second set of traffic flows, the processing system is configured to cause the access point to:
communicate the second set of traffic flows via a second communication channel associated with a second interference level, wherein the first set of traffic flows are communicated via a first communication channel associated with a first interference level, and wherein communication of the second set of traffic flows is via the second communication channel based at least in part on the second interference level being less than the first interference level.

12. The access point of claim 1, wherein:
the second communication resource configuration comprises a plurality of parameters adjusted with respect to the first communication resource configuration, and
subsets of the plurality of parameters are adjusted sequentially in time between the first time occasion and the second time occasion with respective back-off time durations between adjustments of respective subsets.

13. A first access point, comprising:
a processing system that includes processor circuitry and memory circuitry that stores code, the processing system configured to cause the first access point to:
communicate, at a first time occasion, a first set of traffic flows with a first set of client wireless communication devices, wherein the first set of traffic flows is associated with a first airtime demand that is less than or equal to a first threshold airtime availability associated with a communication resource configuration at the first access point;
communicate, after the first time occasion and with a second access point, a backhaul message that indicates for the second access point to service at least one traffic flow of a second set of traffic flows based at least in part on the second set of traffic flows being associated with a second airtime demand that is greater than the first threshold airtime availability, wherein the second set of traffic flows comprises at least the first set of traffic flows and includes the at least one traffic flow and a remainder of the second set of traffic flows; and
communicate, based at least in part on the backhaul message, the remainder of the second set of traffic flows with one or more client wireless communication devices of the first set of client wireless communication devices, wherein the remainder of the second set of traffic flows is associated with a third airtime demand that is less than or equal to the first threshold airtime availability.

14. The first access point of claim 13, wherein the processing system is further configured to cause the first access point to:
receive, from a set of neighbor access points, one or more reports that indicate communication link metrics associated with respective communication links between the set of neighbor access points and the first set of client wireless communication devices, wherein the set of neighbor access points comprises the second access point, and wherein communicating the backhaul message is based at least in part on a respective link metric associated with a respective communication link between the second access point and a client wireless communication of the first set of client wireless communication devices that is associated with the at least one traffic flow satisfying a communication link metric threshold.

15. The first access point of claim 14, wherein the processing system is further configured to cause the first access point to:
receive a stream classification service request message for a traffic flow from a client wireless communication device that indicate a first traffic identifier associated with the traffic flow; and
communicate, based at least in part on the second set of traffic flows being associated with the second airtime demand that is greater than the first threshold airtime availability and based at least in part on respective link metrics associated with respective communication links between the set of neighbor access points and the client wireless communication device failing to satisfy the communication link metric threshold, the traffic flow in accordance with a second traffic identifier that is associated with a lower priority than the first traffic identifier.

16. The first access point of claim 14, wherein the communication link metric threshold is a latency threshold.

17. The first access point of claim 13, wherein:
the backhaul message indicates for the second access point to service one or more traffic flows associated with a first client wireless communication device of the first set of client wireless communication devices,
the one or more traffic flows comprise the at least one traffic flow, and
the one or more client wireless communication devices comprise a remainder of the first set of client wireless communication devices other than the first client wireless communication device.

18. The first access point of claim 13, wherein:
the backhaul message indicates for the second access point to service a subset of traffic flows associated with a first client wireless communication device and a second client wireless communication device of the first set of client wireless communication devices,
the subset of traffic flows comprises the at least one traffic flow, and
the one or more client wireless communication devices comprise a remainder of the first set of client wireless communication devices other than the first client wireless communication device and the second client wireless communication device.

19. The first access point of claim 18, wherein the backhaul message indicates for the second access point to service the subset of traffic flows based at least in part on:
the first client wireless communication device and the second client wireless communication device are non-service level agreement clients of the first access point; and
the first access point determining not to steer at least one or more client wireless communication devices of the remainder of the first set of client wireless communication devices that are service level agreement clients of the first access point to the second access point.

20. A method for wireless communications at an access point, comprising:
communicating, at a first time occasion, a first set of traffic flows with a first set of client wireless communication devices in accordance with a first communication resource configuration associated with a first threshold airtime availability, wherein the first set of traffic flows is associated with a first airtime demand that is less than or equal to the first threshold airtime availability; and
communicating, at a second time occasion that is after the first time occasion, a second set of traffic flows with a second set of client wireless communication devices in accordance with a second communication resource configuration associated with a second threshold airtime availability, wherein the second set of client wireless communication devices comprises at least the first set of client wireless communication devices, wherein the second threshold airtime availability is greater than the first threshold airtime availability, wherein the second set of traffic flows is associated with a second airtime demand that is greater than the first airtime demand, and wherein communication in accordance with the second communication resource configuration is based at least in part on the second airtime demand exceeding the first threshold airtime availability.
